(19) United States
(12) Patent Application Publication
(10) Pub. No.: US 2023/0206363 A1
(43) Pub. Date: Jun. 29, 2023

(54) METHOD AND SYSTEM FOR AUDITING, CREATING, STORING AND/OR ISSUING DIGITAL POWERS OF ATTORNEY AND OTHER LEGAL AND/OR RELATED HEALTH DOCUMENTS

(71) Applicant: 2715158 ONTARIO LIMITED, Milton (CA)

(72) Inventors: Nathan SPALING, Milton (CA); Helen CHEN, West Montrose (CA); Kathleen LAVOIE, Kitchener (CA); Jasmine SWEATMAN, Oakville (CA); Michael SPALING, Edmonton (CA)

(21) Appl. No.: 17/768,950

(22) PCT Filed: Oct. 16, 2020
(86) PCT No.: PCT/CA2020/051396

§ 371 Date: Apr. 14, 2022

Related U.S. Application Data
(60) Provisional application No. 62/915,897, filed on Oct. 16, 2019.
(60) Provisional application No. 63/048,707, filed on Jul. 7, 2020.

(51) Int. Cl. G06Q 50/18

(52) U.S. Cl. CPC G06Q 50/18

(57) ABSTRACT

A system and method for creation, auditing and management of legal documents. The method may include confirming if legal documents that have been requested by the system are valid in the jurisdiction where the request is being made. If so, the legal document can be released. If the legal document does not exist, such as with a Power of Attorney (POA), the system may assist to generate a POA and determine if a capacity assessment is required.

### CROSS-REFERENCE TO OTHER APPLICATIONS

The current disclosure claims priority from U.S. Provisional Application Nos. 62/915,897 filed Oct. 16, 2019 and 63/048,707 filed Jul. 7, 2020, both of which are hereby incorporated by reference.

### FIELD OF THE DISCLOSURE

The present disclosure relates generally to legal and/or related health documents a method and system for auditing, creating, delivering, activating and/or managing powers of attorney (“DPOA”) and other legal documents. The disclosure also relates to a method and system administering capacity assessment and undue influence examinations/screenings.

### BACKGROUND OF THE DISCLOSURE

Conventional legal documents and capacity assessment reports have been generally stored and accessed (to the extent possible) in hardcopy form (by the clients, legal professionals and related third parties) and this method of storage not only creates inefficiencies within the daily operations of creating and managing these documents but also inefficiencies of the clients, legal professionals and end-users accessing these legal documents (including but not limited to client intake sheets, powers of attorney, Wills, capacity assessments [by a lawyer, a lay-person witness or certified capacity assessor], consents to act, accounting/tracking the use of the legal documents, notices of revocation or resignation and final reports).

Law firms, like most businesses, use digital computers and networking technology to manage different types of data. Much of this data can be handled internally by the legal professional, the client or the third party without specialized software or hardware. However, some legal documents and/or related health documents require ability to track, audit, activate, create, deliver, archive the communication related to this legal documentation and/or related health documentation. Among other things, the conventional software used to store legal documents also does not allow for remote access or off-site viewing and reporting for clients and related parties. This specialized software is the legal picture archiving communications system (known as the “Electronic Legal Record”).

If a person (“Grantor”) cannot make a decision on their own behalf because (1) they do not have capacity to do so; or (2) they are not physically present to do so—then only an appointed substitute decision maker or an authorized representative can legally make a decision on the Grantor's behalf. The substitute decision maker may be referred to by using different terminology in various jurisdictions, including but not limited to, the grantee, agent, or attorney (collectively referred to as the “SDM”).

Powers of attorney (“POA”) are the most common way to control who is the authorized SDM and what the scope of their authority is along with being able to control the criteria around when the SDM can use the authority. At its broadest the scope, the SDM's authority under a POA is generally distinguished between: appointments of a person(s) for decisions that manage the Grantor's property; and, appointments of a person(s) for decisions involving the Grantor's health and care decisions.

Grantors often provide very broad authority to the SDM, over all property rights or health care decisions, because in the event that the Grantor is not capable to make her/his own decisions then it could have significant health, financial and/or social consequences if their authority had specific limitations and no other person able to make such decision. This means that any interaction that a for-profit, not-for-profit or charitable business/organization could have with a Grantor, must also accommodate the same instruction from the Grantor's SDM and thereby this broad authority can increase the risk of abuse or misuse by the SDM or an incorrect SDM.

The risk of abuse or misuse of the POA's authority is often related a series of procedural and substantive difficulties that arising around the time of executing the document and/or assessing the validity of an executed POA. Some specific examples of these procedural and substantive issues.

With these processes, there are procedural timing and storage issues such as, among others, listed below.

Last-in-Time: The authority of an SDM is almost always reliant on the POA being the most recent version, however there is no centralized repository that tracks this “last-in-time” status or notifies the former SDM (or the lawyer storing the POA) that their authority is revoked if a more recently executed POA of the Grantor is found.

Document-in-Hand: In order for the SDM to be able to use the authority under the POA, the SDM must have the POA present at the time that the first decision is being made with the particular individual. For example, if the POA is needed to make a medical decision at a retirement home, then if there is no record of the POA or SDM being authorized to make such decision and that SDM does not have the POA, then such authority under the POA is as though it does not exist. This is issue is further complicated because these documents are executed and stored in hardcopy form and additionally not every SDM knows that they are appointed as the SDM let alone where the Grantor stores the POA. The SDM is almost always required to be physically present to make a decision on behalf of the Grantor.

SDM Contact Information: In the event that a Grantor arrives at an institution without capacity but they knew the name of the SDM, it is very unlikely that the institution would have the SDM's contact information or what limitations there may be on their authority to act as the Grantor's SDM.

In-person Signing: Traditionally, the Grantor must be in the same room as the witnesses when signing the POA. However, with certain people not having the ability to be physically in front of the witnesses for a number of reasons, including but not limited to there being any mobility issues, capacity concerns, a lack of transportation or health concerns prevents people from signing a POA. A need exists to complete this process (or any part thereof) virtually including but not limited to signing the document virtually and/or electronically. There is currently no instruction that is accepted as a recording.

Understanding the Jurisdictional Formalities: The person that receives an existing DPOA (from either a Grantor, SDM or a third party) must make a decision if the DPOA has met the jurisdictional formalities (along with any supplementary company policies from time to time) before accepting the instructions of the SDM. With the added virtual execution procedures throughout each jurisdiction, this analysis is becoming inherently more complex to assess with confidence.

Activating the SDM Authority: Often the Grantor elects to have the SDM's authority become effective as of the date the Grantor is assessed to be incapable. This often leads to significant delays while the Grantor is being scheduled in for an assessment and the SDM/Grantor must keep track of the hardcopy assessment in order to deliver it to each requisite institution before the SDM can exercise their authority under the DPOA.

Communication with SDM and the End-Users: Acting as an SDM is often a significant time commitment which requires frequent traveling to institutions for signing, or authorization phone calls. This often leads to individuals not wanting to consent to act as the SDM, despite potentially being entitled to receive compensation under the POA.

With respect to the execution of POAS, there are some other hurdles that complicate the POA execution process.

Legal Professionals Are Not Trained to Assess Capacity: Legal professionals generally do not have the appropriate training or information to detect a client's cognitive vulnerabilities that may impair their ability to execute or revoke a POA or their vulnerability to potential undue influence. This is partially because capacity assessments are not mandatory requirements in law schools but also legal professionals are not typically able to interpret relevant medical information/history to understand their client's vulnerabilities. Legal professionals who draft these documents that are later challenged are often criticized for the warning signs that they did not probe further or recognizing when the lawyer was beyond their competence to continue.

Untrained Witnesses: Similar to the problem above with the legal professionals not having formal capacity assessment training, the POA does not require a capacity assessment or a properly trained witness to sign the POA. Therefore, the witnesses to the POA are often not adequately trained to confirm the capacity of the Grantor. This includes the ability to screen for cognitive impairments that may limit a Grantor's ability to execute the POA. Since capacity is a threshold question, this threshold may be viewed differently by the witnesses. As such, a need exists to provide a digital process and/or system to facilitate the capacity assessing process to execute/revoke a DPOA which must be used prior to the DPOA creation, along with an optional baseline test of capacity to be used during subsequent questions of incapacity.

Inefficient Cross-Discipline Communication: The inability for the Grantor, the SDM, the capacity assessor, the lawyer and/or the end-user to communicate in a common place and in a common language makes it nearly impossible for this highly-sensitive process to function efficiently and effectively to meet the time sensitive decisions. Scheduling and receiving a capacity assessment report can be a timely process which then has to be delivered to the person or institution receiving the DPOA that is effective upon the Grantor's incapacity. Whereas the alterative method of appointing an SDM through a guardianship application, going to the Consent and Capacity Board or hiring a capacity assessor as significantly more expensive and time consuming. Accordingly a need exists to connect the DPOA to the findings of capacity as it relates to managing property or making health care decisions.

Therefore, this is providing a novel method and system for auditing, creating, storing, requesting and/or issuing DPOAs or legal (and/or related health) documents (functioning, at least in part, as a registry and/or comprehensive database) along with a method/system for identifying when the SDM's authority is effective and/or when it may not be effective together with a communications platform for each party to a DPOA to communicate with each other to provide notices and logging information related to the use of the DPOA or legal documents and/or related health documents.

### SUMMARY OF THE DISCLOSURE

The disclosure is directed at a method and system for auditing, creating, delivering, activating and/or managing powers of attorney (“DPOA”) and other legal documents and health related documents. In one embodiment, the disclosure may be seen as a picture/data archiving and/or communication system of legal and/or health documents, including the related processes to these legal and/or health documents. This includes, among other things, a method and system for auditing, creating, delivering, activating and/or managing powers of attorney (either paper-based and/or electronic form, herein collectively referred to as “DPOA”), capacity assessments and/or other notarized/legal documents/communications including but not limited to tracking the communication, transaction details, use and notices between the relevant parties.

In one embodiment, managing the DPOA may be include auditing, creating, storing, requesting and/or issuing DPOAs and/or other related health documents containing personal or confidential information, including but not limited, to notarized documents, capacity assessments, communications between the relevant parties that create, audit or rely on the DPOA and/or health related records, on-boarding documents and/or service agreements (“Documents”).

In one aspect of the disclosure, there is provided a method of managing a power of attorney for a grantor including obtaining a current power of attorney for the grantor; determining if the grantor requires a capacity assessment; administering the capacity assessment; administering an undue influence assessment; based on results of the capacity assessment, storing the current power of attorney; and releasing the power of attorney once activated.

In another aspect, obtaining the current power of attorney includes determining if the grantor has an existing power of attorney; and obtaining the existing power of attorney as the current power of attorney if one is found or generating a new power of attorney as the current power of attorney. In a further aspect, determining if the grantor requires a capacity assessment includes generating a set of questions for the grantor to answer; processing responses to the set of questions; and determining if grantor has capacity or has been unduly influenced based on responses to the set of questions. In yet another aspect, wherein determining if grantor has capacity or has been unduly influenced is based on a first scoring system that identifies the clients risks of cognitive vulnerabilities based on information automatically received from the cognitive screening module, the intake module, medical information module; a second scoring system that identifies the inconsistent responses with the capacity threshold being measured in the jurisdiction; prompted characteristics or indicia of the court that are either red flags for incapacity or undue influence or the courts have found to be signs of incapacity or undue influence or a person administering the capacity assessment or undue influence assessment confirming their decision. In an aspect, the set of questions include questions relating to a financial situation of the grantor, questions relating to spending patterns of the grantor, questions relating to property ownership of the grantor, questions relating to dependents of the grantor, questions relating to daily tasks of the grantor, or questions relating to health of the grantor. In another aspect, obtaining the existing power of attorney includes searching a database for the existing power of attorney; confirming that the grantor is same as individual associated with the existing power of attorney; and storing the existing power of attorney as the current power of attorney and revoking authority of conflicting powers of attorney. In another aspect, before storing the existing power of attorney, determining if the existing power of attorney meets all jurisdictional formalities.

In another aspect, the method further includes receiving a request from a requestor for the current power of attorney; and obtaining consent from the grantor or a substitute decision maker (SDM) to transmit the current power of attorney to the requestor. In a further aspect, obtaining consent from the SDM includes determining if the SDM has been authorized by the grantor to make a decision on behalf of the grantor; confirming identification of the SDM; and obtaining consent from the SDM to transmit the current power of attorney. In another aspect, determining if the SDM has been authorized includes alerting the SDM that the request for the current power of attorney has been received.

In another aspect of the disclosure, there is provided system for managing a power of attorney (POA) for a grantor including a processor including a set of modules for managing a POA, the set of modules including: an intake module; a cognitive screening module; a medical information module; a capacity assessment module; a POA generation module for generating the POA; and a POA database for storing the POA.

In another aspect, the system further includes a substitute decision maker (SDM) verification module for determining if an individual is able to act for the grantor. In yet another aspect, the capacity testing module generates questions for performing a capacity assessment and processes responses to the questions to determine if the grantor has capacity. In yet a further aspect, the capacity testing module further determines any increased risk of cognitive impairment. In yet another aspect, the system includes a cognitive screen module, capacity assessment module and medical information module to determine if the grantor's capacity is at high risk. In yet a further aspect, the cognitive screen module, capacity assessment module and medical information module activates the power of attorney if the grantor's capacity is not at high risk. In another aspect, the determination is based on a scoring system. In an aspect, the system further includes a communication module for enabling communication between the system and user devices. In another aspect, the communication module further controls access to the system to predetermined individuals.

In another aspect of the disclosure, there is provided a computer-implemented method for managing a power of attorney (POA) for a grantor, including under the control of one or more computer systems configured with executable instructions, obtaining a current power of attorney for the grantor; determining if the grantor requires a capacity assessment; administering the capacity assessment; administering an undue influence assessment; based on results of the capacity assessment, storing the current power of attorney; and releasing the power of attorney once activated.

In a further aspect, the first scoring system is based on at least one of a set of pre-identified risk factors in the set of questions for the grantor; responses to questions associated with a summary of prospective cognitive vulnerabilities; information that is verified versus not verified; legal criteria for capacity threshold within a jurisdiction; and an assessor or witness opinion score.

In another aspect, the method further includes completing the new power of attorney via a virtual or electronic methodology. In another aspect, the method further includes completing the new power of attorney via hardcopy printout and signature. In yet a further aspect, the method includes storing the signed hardcopy. In an aspect, the method further includes automatically completing an affidavit for witnesses. In yet another aspect, the method further includes storing a video file associated with directions in the new power of attorney. In another aspect, the video recording includes the grantor and a predetermined set of witnesses. In yet another aspect, the method further includes automatically notifying individuals associated with the current power of attorney when it is revoked. In another aspect, generating the new power of attorney further includes receiving a digitally signed copy of the new power of attorney. In another aspect, generating the new power of attorney further includes receiving a digital copy of an uploaded hardcopy of the new power of attorney.

In a further aspect of the disclosure, there is provided a method of managing legal documents including receiving a request for a legal document; verifying that the legal document satisfies requirements for use in the jurisdiction where it is to be used; and releasing the legal document if requirements are satisfied.

In another aspect, verifying that the legal document satisfies requirements includes determining if an execution date of the legal document pre-dates all other versions of the legal document. In another aspect, verifying that the legal document satisfies requirements includes determining if a legal professional had the appropriate credentials to complete notarization or witnessing requirements of the legal document. In another aspect, verifying that the legal document satisfies requirements includes determining current jurisdiction where request for the legal document is coming from; determining execution jurisdiction where legal document was executed; and determining if criteria for execution of the legal document in the execution jurisdiction complies with the requirements for use in the current jurisdiction. In yet a further aspect, the method includes providing access to the legal document to permitted viewing persons. In yet another aspect, the method includes rejecting the request for the legal document if requirements are not satisfied.

In another aspect of the disclosure, there is provided a method of auditing jurisdictional formalities in a power of attorney including receiving an input associated with a jurisdiction where power of attorney is to be used; receiving an input associated with a jurisdiction where the power of attorney was executed; receiving an execution date of the power of attorney; receiving a grantor's name; searching system for an existing power of attorney; modifying required fields of the existing power of attorney; and determining if jurisdictional formalities are met.

In an aspect, the method further includes at least one of notifying user of deficiencies; notifying user that jurisdictional formalities have been met; and generating a notification that there are outstanding jurisdictional formalities to be met. In another aspect, information is received via OCR technology. In another aspect, notifying user of deficiencies includes notifying the user of results of missing information. In another aspect, generating the notification that there are outstanding jurisdictional formalities to be met are received from a substitute decision maker; a grantor; a legal professional; a witness; a capacity assessor or a third party end user.

In yet a further aspect of the disclosure, there is provided a method of determining an effective legal document including obtaining a stored version of the legal document and determining a stored version execution date; comparing the stored version execution date with a current version execution date of a current version of the legal document; wherein if the stored version execution date is later than the current version execution date, a last in time version of the document is deemed to be the stored version, and if the stored version execution date is earlier than the current version execution date, the last in time version of the document is deemed to be the current version; and updating the stored version of the legal document if the last in time version of the document is the current version.

In another aspect, the method further includes inputting if the legal document is effective immediately or upon incapacity; receiving supporting documentation; receiving consent from a substitute decision maker; and automatically updating the stored version of the legal document if the last in time version of the document is the current version. In a further aspect, access to the system is restricted to qualified individuals. In another aspect, the qualified individuals include legal professionals, a grantor, a substitute decision maker, a capacity assessor or an individual at an institution.

In yet another aspect of the disclosure, there is provided a method of generating a power of attorney for a grantor including obtaining grantor information; pre-populating a power of attorney template with the grantor information; generating a power of attorney document based on the power of attorney template with the grantor information; and obtaining an electronic or digital signature for the power of attorney document.

In another aspect, after generating the power of attorney document determining if the grantor needs a capacity assessment. In an aspect, the method further includes automatically generating the capacity assessment if the grantor needs the capacity assessment; and determining if the grantor has capacity based on responses to the capacity assessment. In another aspect, determining if the grantor has capacity is based on a scoring system of the responses or a report of a qualified capacity assessor. In another aspect, the digital signature includes a video recording. In another aspect, the stored version of the legal document may be invalidated due to predetermined criteria. In yet another aspect, the predetermined criteria includes a capacity assessor determining the grantor does not have capacity. In another aspect, the method further includes generating a reporting letter that is pre-populated with information from the power of attorney document. In an aspect, the method further includes determining if the power of attorney document should be activated based on the capacity assessment. In an aspect, the method further includes activating the power of attorney document if the grantor has passed the capacity assessment. In yet a further aspect, the method further includes obtaining medical information from the grantor; determining side effects or potential cognitive impairments based on the medical information; and determining if a capacity assessment should be administered based on the side effects or potential cognitive impairments.

### DESCRIPTION OF THE DRAWINGS

Embodiments of the present disclosure will now be described, by way of example only, with reference to the attached Figures.

FIG. 1 is a diagram of a system for digitally managing legal documents;

FIG. 2 is a schematic diagram of the various modules in the system;

FIG. 3a is a flowchart outlining one method of auditing, uploading, requesting and issuing DPOAs;

FIG. 3b is a flowchart outlining another method of auditing, uploading, requesting and issuing DPOAs;

FIG. 3c is a flowchart outlining a further method of auditing, uploading, requesting and issuing DPOAs;

FIG. 4 is a flowchart outlining a method to create, execute and/or audit a DPOA digitally;

FIG. 5 is one embodiment of some information that may be required to be input for a DPOA;

FIG. 6a is a flowchart outlining a method of providing a DPOA to a requesting party;

FIG. 6b is a flowchart outlining a method of requesting the use of a DPOA, contacting the SDM and the authentication/verification for use in a system for issuing a DPOA;

FIG. 6c is a flowchart outlining another method of requesting the use of a DPOA, contacting the SDM and/or the authentication/verification for use in a system for issuing DPOA;

FIG. 7a is a flowchart outlining a method of automatic auditing of a DPOA;

FIG. 7b is a flowchart outlining another method of automatic auditing of a DPOA;

FIG. 8a is a table showing required information for generating a DPOA;

FIG. 8b is a table showing a list of medical information questions;

FIG. 8c is a table showing a list of cognitive screening questions; and

FIGS. 9a to 9f are schematic diagrams of screenshots that a user may see when the system of the disclosure.

### DESCRIPTION

The disclosure is directed at a method and system for auditing, creating, delivering, activating and/or managing powers of attorney (“DPOA”) and other legal documents and/or health related documents. In one embodiment, the disclosure may be seen as a picture/data archiving and/or communication system of legal and/or health documents, including the related processes to these legal and/or health documents. This may include a method and system for auditing, creating, delivering, activating, revoking and/or managing powers of attorney (either paper-based and/or electronic form, herein collectively referred to as “DPOA”), capacity assessments and/or other notarized, legal and/or health documents/communications including but not limited to tracking and logging the communication, transaction details, use and notices between the relevant parties.

In another embodiment, the creation of a new power of attorney (either for digital execution or hardcopy execution) includes the use of questions and information to gather to screen for cognitive impairments, questions and/or information to gather to support the likeliness of a capacity or incapacity decision to be made by the witness(es), questions and/or information to gather to assess by the witnesses to assess any undue influence. In a further embodiment, when creating or auditing the DPOA, the system automatically assesses if the power of attorney has complied with the jurisdictional formalities of the place that it was executed in;, to receive information or execute a DPOA or a POA (including but not limited to capacity of for a Grantor and if any undue influence is present at the time of instructions or execution of a POA and/or DPOA);

In another embodiment, the disclosure is directed at a method and system of handling legal documents or related health documents. In one embodiment, the disclosure includes to ensure confirming that the jurisdictional formalities were (or likely were) met at the time of execution.

In another embodiment, the disclosure includes a method of contacting an appointed substitute decision maker (“SDM”) or an authorized representative that can legally make a decision on the Grantor's behalf (with or without knowing the DPOA exists), requesting the use of the POA and the authentication of the SDM. In another embodiment of the system, the SDM, capacity assessor or Authorized User may log certain uses/information of the DPOA or items related to the performance of their duties including, but not limited to, sending consent to accept the appointment, renouncing appointments or declining the appointment. In situations where a capacity assessment may be required, the capacity assessor may also access the system.

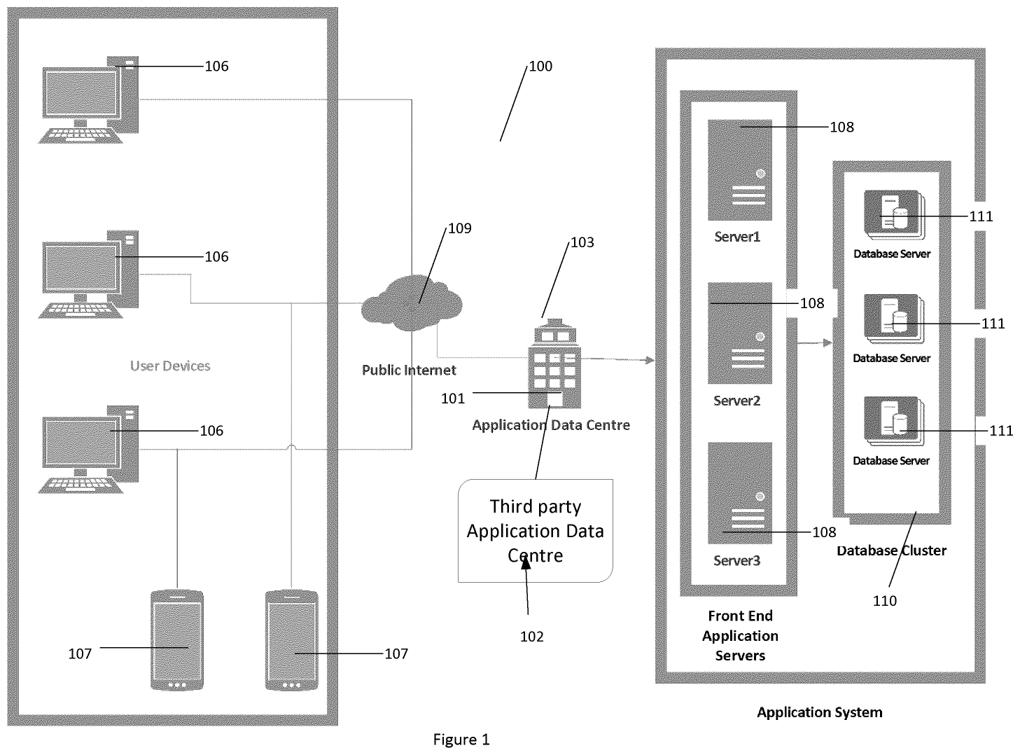

Turning to FIG. 1, a diagram of an environment for a system for managing legal and related health documents and/or communication. In one embodiment, the environment may be for a system for managing legal documents and/or related health documents that as part of their validity rely on being the most recent document executed, including but not limited, to powers of attorney, Wills, notarized documents, capacity assessments, advanced directives, living wills, related health information and/or other related documents/communication between the parties (collectively “Estate Documents”). In another embodiment, the environment may be for a system for managing powers of attorney and all related communications, all related health documents to the power of attorney and/or capacity assessing process.

In the current embodiment, the system may be used by the legal professional for auditing, creating, uploading, tracking, storing, delivering and/or issuing any of the legal documents and/or related health documents, communication or information provided by the users to the system or related to the processes. Legal professional may include (for reference throughout this entire application), but is not limited to, lawyers, (both barristers and solicitors), attorney-at-law, paralegals, notary publics, notaries, or any person or company that is authorized to certify the authenticity of a document in a particular jurisdiction. One aspect of this embodiment may allow the legal professionals to be the administrators and control the remote access by the other people/entities needing this information. In this aspect, the lawyer and/or client would provide use of the Estate Documents to system to ensure they are compared with other Estate Documents—this may be done using the system's application data centre 103 or by a third party's application data centre, servers, databases, repositories or storage places interacting with the system's application data centre 103. In one embodiment, legal professional's credentials must be input upon entry to the system and in another embodiment, legal professionals complete a pre-user form to be validated and granted access with credentials to be reviewed at specified intervals. In another embodiment, the legal professional and/or the health care professional may be the administrator of the system.

In another embodiment the system and/or the third party application data centre or third party server 102 may be used by non-legal professionals (including but not limited to the Grantor and/or the Grantor's witnesses) and/or another legal-software company for auditing, creating, tracking, storing, deliver and/or issuing any of the legal documents, Estate Documents, communication or information provided by the users of the software.

The system provides role-based controls as to who can access the information/document of a particular client remotely and what information/documentation can the various roles access/contribute/manipulate. The role-based controls may be customized by the client and/or legal professional, but specific minimum access rights will be permitted to (among other specified entities) other legal professionals, law firms, clients of the legal professional, other legal software companies, substitute decision makers, capacity assessors, witnesses to legal documents, health care institutions/organizations, home care coordinators, financial organizations and the general public. For example, regardless of who the administrator is, a capacity assessor would always have the ability to upload a capacity assessment to the system which would in-turn make a substitute decision maker's authority under a power of attorney for care activated (subject to the SDM's consent to act). Each of these parties listed above will have a specified type of access to the information/documentation.

In one embodiment the user (such as a legal professional) may store all of its professional data on this application data base 103 and control the access of the relevant parties to the Estate Documents along with permitting certain information used from their Estate Documents to be used in the broader database searches to ensure that the Estate Document does not have a more recently executed version with conflicting information. In another embodiment the legal professional may have its own storage system 102 and provide access for only the Estate Documents to ensure that the Estate Documents does not have a more recently executed version with conflicting information. The same alternative embodiments may exist for the non-professional's use in situations where the non-professional users an application data centre as in 102 or 103.

In one embodiment of the system only legal professionals are able control the role-based access. For example, the legal professional may allow a client to have remote access to any file within the client's file in the legal professionals application data centre or the legal professional may exclude specific documents like (but not limited to) invoices and/or personal notes/memorandums.

The environment 100 includes an application data centre (ADC) 103 that stores the system for uploading, auditing, storing, requesting and/or issuing a Estate Documents 101. The ADC 103 communicates with users (seen as computers 106 and/or mobile devices 107) via a network, such as the Internet 109, and institution servers 108. In one embodiment, each of the servers 108 is connected to a database cluster 110 that includes a plurality of database servers 111. The institution servers 108 may form a server cluster 112. In the same or another embodiment, the application data centre 103 may also interact with a third party's application data centre 102 and/or servers and/or database in the same clusters or pluralities as above.

Although shown as desktop computers, it will be understood that the users may communicate with the ADC 103 via other computing devices, such as, but not limited to, tablets, laptops, and the like. Communication between the users 106 and the ADC 103 and the ADC 103 and the institution servers 108 will be via known communication protocols.

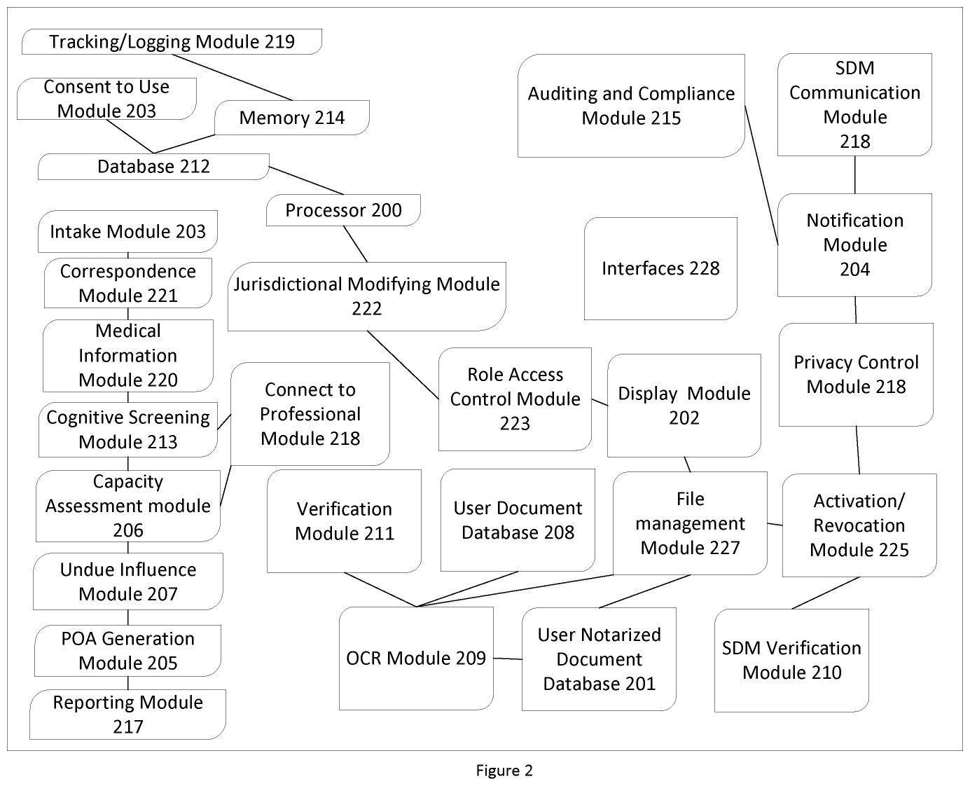

Turning to FIG. 2, a schematic diagram of the various modules in the system is shown. It will be understood that not all connections between modules are shown in the Figure for clarity reasons. While shown as individual modules, it will be understood that multiple modules may be combined into a single to provide the functionality of those combined modules. It is understood that all of the modules may be connected to a central hub where communication between the modules is enabled. In one embodiment, the system 101 is housed or located within the ADC 103 which, in one embodiment, may be a server. The system 103 includes a database 212, consent to use the database 224, memory 214 and tracking/logging module 219 along with a processor 200 which is connected directly or indirectly to the display module 202. The memory 214 may store instructions to be executed by the processor 200. The processor 200 may also be connected with either combination of the jurisdictional modifying module 222 and/or the role access control 223 and/or the Auditing and Compliance module 215. The system 103 further includes modules that assist to a user to complete the drafting of Estate Documents (including but not limited to a DPOA), which includes a Correspondence Module 221, an intake module 203, medical information module 220, a cognitive screening module 213, a capacity assessment module 206, an undue influence module 207, a POA generation module 205, reporting module 217, connect to professional module 216. The system also includes a verification module 211, an OCR module 209, user document database 208, user notarized document database 201, file management module 227, activation/revocation module 225, a SDM verification module 210, a notification module 204, SDM communication module 218. Finally, the privacy control module 226 allows the user and/or administrator to control all items that are displayed to other users (subject to the terms of the consent to use 224, for example a user would have to permit the Estate Documents to be cross referenced with the appropriate Estate Documents databases).

In use, the display module 202 operates to generate, and/or transmit images, or screens, that are displayed on the user devices 106 or 107, subject to the rules in place by the privacy control module 226. For instance, the display module 202 may generate screens for display to a user. The display module 202 may also perform the necessary actions to convert images from other modules into a format that is viewable on the user's particular device. The notification module 204 includes the firmware, such as apparatus, components or software, for the system 103 to communicate with the user device(s) 106, 107 and/or institution servers 108. The institutional servers 108 may be located within either application data centre 102 or 103. In an alternative embodiment, the system 103 may include multiple communication modules with one communication module to communicate with user devices and one communication module to communicate with institution devices or other interfaces 228, such as financial institutions, health care institutions, long-term care institutions, interRAI capacity assessments, point click care, software, other registries of Estate Documents. In a further embodiment, the communication is performed wirelessly via any known telecommunication networks. Therefore, the components within the notification module 204; along with any execution meeting or connecting to professional 216 may be any components that enable wireless communication with the user device(s) and/or the server(s) (including but not limited to meeting via video or using other virtual means). In one embodiment, secure cloud storage hosted in specific jurisdictions enables the system and method of the disclosure to be realized and comply with certain regulatory requirements related to the holding and movement of personal information through the Auditing and Compliance Module.

The modules 221, 203, 220, 213, 206, 207, 205, 217 and/or 216 may be used independently of each other or in any combination with another(s) or as one complete embodiment of completing the process to create certain Estate Documents (the “Creating Estate Documents”). The sequence of the Creating Estate Documents process may be interchanged with any of the other modules in the process. In one embodiment, the Creating Estate Documents process may be exclusively completed by the Grantor (and/or an authorized person on the Grantor's behalf), a legal professional and/or a capacity assessor. In an alternate embodiment it may be completed by either a legal professional and/or a non-legal professional witness and/or capacity assessor.

The Jurisdictional Modifying Module 222, is selected (or may be set as a default setting), and provides the functionality to modify or adjust any documents to specific jurisdictional requirements. For example, if Ontario is the selected province, then the requirements for the intake module 203 would change to reflect the information that a legal professional would require to satisfy their professional obligation of “knowing their client” to authenticate or verify the client's identity. The client in this may be a substitute decision maker, a Grantor or a third party making a request for information. In the event that something does no

The intake module 203 operates to receive the required information about the requisite role-based profile, or individual, accessing the system. Simply, this captures information that will be used to create a profile for either a client beginning to create an Estate Document, verify/upload an Estate Document or create their profile to interact as a capacity assessor, substitute decision maker, and/or third party requesting information. In another embodiment, a Grantor could enter the required information to execute the legal documents and/or the required information for a capacity assessment to be conducted, and/or for example to execute a DPOA. Additional information that is provided in this intake module 203 may relate to the Grantor's living family members (including biological or non-biological family) and understanding the dependencies that may exist between them and/or who will be part of the estate planning process. In one embodiment a family member may be used to verify certain information provided in the capacity assessment by the Grantor. The information from the intake module 203 may be used to automatically prepopulate certain fields in other modules and/or may trigger certain prompts (depending on the responses) in different modules. This form may be printed in hardcopy form and uploaded, digitally signed or completed using the application and submitted. In one embodiment, prompts will be provided for the user to explain a required field differently than it is stated and/or alternatively, the user would have the ability to connect to a professional via the connect to a professional module 216 capable of providing advice to explain the field. In one embodiment, this module may also be connected to the verification module 211 in the event the Grantor already has a valid POA and does not want to change it.

The Correspondence module 221, includes a list of template forms to be used by the user. The list of forms includes, but is not limited to, engagement letters, retainer agreements, consent to act as a substitute decision maker, directions, notices of revocation, affidavits of execution. For example, in one embodiment, the standardized content will have fields that automatically pull certain information about the Grantor from the Intake Module 203, like the Grantor's name and what services they are accessing in order to pre-populate a letter of engagement for a Grantor to execute a POA and/or any other Estate Document. All notices, letters of engagement, retainer agreements, consents to act, directions notices of revocation, affidavits of execution or any other Estate Document in this Correspondence module 221 will be in the form specified by the requisite jurisdiction and/or law society and may automatically be sent using the system's functionality.

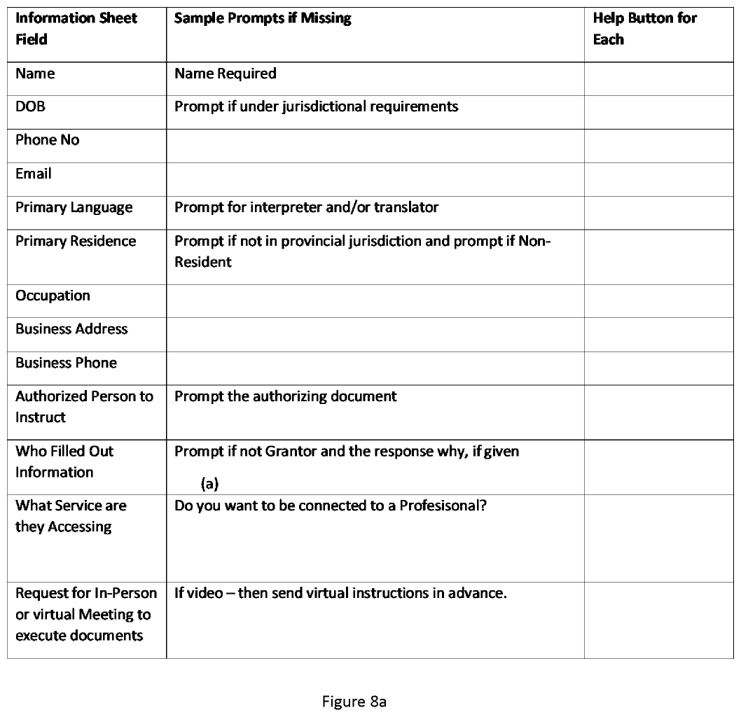

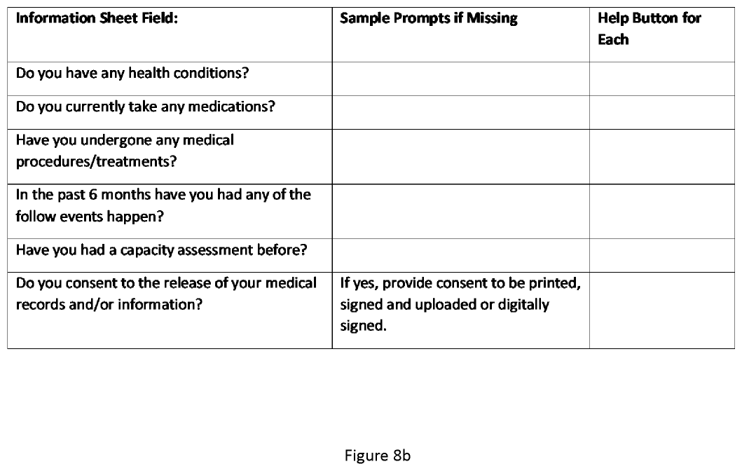

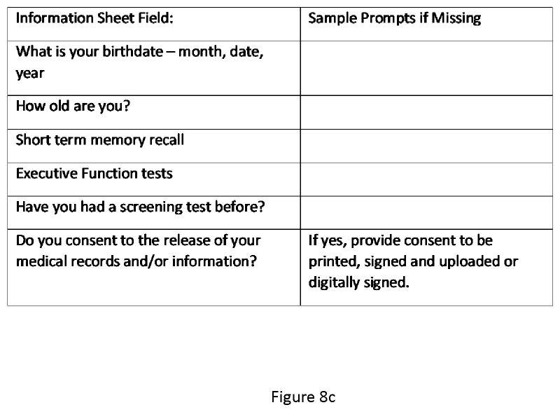

The medical information module 220 operates to receive voluntary medical information about the client or an individual and to inform the legal professional or witness to the Estate Document of prospective cognitive impairment issues or what the medical information means in relation to risks of cognitive impairment. A sample of some of the information that is requested under this form includes, but is not limited to, any of the questions in FIG. 8b. These questions may be presented in a series of ways, either open-ended questions, multiple choice, yes or no, and/or clicking all that apply or do not apply. In one embodiment, the client can provide consent for the legal professional or witness to receive medical records of the Grantor to review in advance of the capacity assessment. In another embodiment the client is asked a series of questions about their medical history/information that the client may choose to respond to or not. In another embodiment, the client can both answer the medical history/information questions and provide access to the medical records. The medication information module 220 may work with other modules in FIG. 2 and use the identified fields in the medical information module and/or in the other modules in FIG. 2 to provide a summary to the legal professional and/or witness(es) of the risks of cognitive impairments. For example, in one embodiment the client may be asked what medication they are currently taking and if the client enters the medication name, the system will automatically process the corresponding side effects and advise the witness or legal professional. In another embodiment, the Grantor may be asked if they have had any treatments or procedures within a specified time period and the system will automatically general a prompt/warning of the potential cognitive risk that it poses. In one embodiment the user will be provided prompts to probe for additional information where needed. In one embodiment, certain information from the medical information module may be used in the cognitive screening exercise, or module, 213 (including but not limited to future cognitive screening), the capacity assessment module 206, the undue influence module, the POA generation Module 205, the activation/revocation module 225 and/or the reporting module 217.

The Cognitive Screening Module may generate a series of questions that the user may use in the event that the medical information 220 has revealed a risk of cognitive impairment that requires further probing to confirm or alternatively, it may be used at the discretion of the user to uncover cognitive impairment risks. This assessment may be carried out by either the professional (legal professional, witness or capacity assessor). The assessment may be carried out (subject to the limitations of an external cognitive screening instrument) virtually or in-person. In one embodiment, the cognitive screening module will provide the user with a score to assess the risk of cognitive impairment by calculating the total number of risk factors present, another embodiment will highlight the areas of questioning to probe for more information and allow the assessor to make the ultimate decision if they would like to proceed. The assessor/witness/legal professional in this situation can always access the Connect to Professional 216 for assistance. The results from this module are saved in the memory 214 and the tracked and logging module 219. Some examples of external screening tools that may interact with the system is the Montreal Cognitive Assessment, an interRAI capacity assessment or the mini-cog. The questions asked by the system under this module, screen for (among other cognitive impairments) potential: aging and cognitive decline, substance abuse, psychosis, mild cognitive impairment, dementia, delirium, depression, bipolar disorder and/or risk of imminent death. The system may provide the user with specific questions database to ask and/or a set of warning signs that the condition may be present and/or a recommended third party cognitive screening instrument to be used. For example, if the Grantor is being screened for dementia, the system may provide warning signs and/or suggest the Mini-cog assessment to support the assessor's decision making on the level/risk of impairment. The system may also make reference to some sample prompts that would educate the user on the warning signs of some cognitive impairments, including without limitation to Depression and/or Delirium.

The Capacity Assessment Module 206 is generally for the legal professionals (in another embodiment for the witnesses). Based on the information collected (even if there is none), the legal professional will automatically be provided what the legal threshold for this capacity is and will provide a series of suggest topics based on the flagged information provided from previous modules for the assessor to probe and satisfy in order to proceed with the Grantor to execute the Estate Document. This legal professionals (in an alternative embodiment, witnesses) have the ability to assess the capacity to provide guidance on the capacity to execute/revoke a Will and/or either power of attorney, advanced care directive, contract, gift, gift real estate. Any other capacity threshold may be referred to the Connect to Professional module 216 where a qualified capacity assessor may be engaged (instantly or scheduled) to provide an assessment for any other capacity threshold, including but not limited to capacity to marry, divorce, reconcile, manage property and/or make a personal care decision along with those thresholds carried out by the legal professional or witness. Using the information provided, the assessor may ask a series of prompted questions (along with any further questions at the discretion of the legal professional or witness—as the case may be), wherein the legal professional/witness or Grantor may fill in the responses/notes (as applicable). The criteria will be automatically modified to reflect the jurisdictional formalities in the jurisdiction that the Grantor is executing the Estate Document in. Some of the fields that will be flagged if all of the prior module information is filled out would include but not be limited to: any dependencies that were noted on children, parent, siblings, or others; anybody else filling out the intake documents on their behalf; financial or health related information provided; any conflict noted with any children, parents, siblings, or others. An example of some of the items from the intake module 203 that may be flagged for further probing the capacity to execute a POA for property, can be seen on FIG. 8c These fields will automatically either carried forward into this module by other fields that were triggered by the corresponding response or an alternative embodiment is they may be substituted by the legal professional or witness providing certain statements to confirm their satisfaction of capacity. The responses provided by the Grantor in the intake module and medical information module can assist the legal professional or witness in confirming that the information matches the original responses.

The POA generation module 205 provides the functionality for the system to automatically generate a DPOA where there is no existing POA stored in the system for a Grantor or where a Grantor simply would like to revoke and replace an existing DPOA. Using the information provided in the intake module 203, correspondence module 221, medical information module 220, cognitive screening module 213, capacity assessment module 206, undue influence module 207, the POA generation module will permit the Grantor to see an automatic draft populated to be able to edit within the module. This POA generation module 205 tracks all changes made (including time stamped and date) by each user. Both the legal professional (or the witness, as the case may be) can complete any suggested edits and confirm acceptance and understanding of the draft. The POA will be then converted into an execution draft along with the prepopulated affidavits with the witnesses to confirm at the time of execution. The POA generation module will provide a schedule to book an appointment to execute the POA or Estate Documents or alternatively may provide a video link to complete this execution virtually. The POA generation module 205 has a variety of types of POAs that can be prepopulated, including without limitation to a power of attorney for care, a limited power of attorney for property, a continuing power of attorney for property and a specific power of attorney for information sharing. The concept of the power of attorney for information sharing is to permit a primary physician to be allowed to provide the treating doctor or circle of care relevant information that they otherwise would not be able to access. The Grantor may execute any and all documents via hardcopy (which would then be uploaded through the OCR module 209 and verification modules 211). In another embodiment, the Grantor may execute all document by either signature on the hardcopy document or by digital signature or by a digital time-stamped signature. In another embodiment, the Grantor may complete all of the prior modules to this POA Generation Module (being modules 203, 221, 220, 213, 206, 207 and if needed 218) and then the Grantor may meet with the witnesses on a video recording and complete all in-person meeting protocols and then verbally instruct (in front of the permitted witnesses and in the number of witnesses required) the direction of the terms, conditions and instructions of the DPOA.

The capacity testing module 206 operates to assist authorized users (being the eligible witnesses or legal professionals to the document/process) to determine if a Grantor has the capacity to execute a DPOA. The POA generation module may also provide the functionality to enable the POA to be signed electronically or via a video signature. The POA generation module may also provide the functionality for audio recording to be obtained whereby the grantor may verbally confirm who the SDM or grantee is for their POA or to confirm the witnesses that are present at the execution of the POA. In one embodiment, the capacity testing module 206 may be completed using video/virtual meetings and/or using in-person meeting. The information may be interacted with using the digital prompts and fields whereas it may also be printed in a hardcopy form. In one embodiment, the capacity testing module may use any information provided by the other modules in FIG. 2 to verify information to probe for more information raised in a prior field. In one embodiment, the capacity testing module 206 may issue an interactive baseline test for the Grantor and based on the Grantor's answers determine (or assist to determine) if the Grantor has the capacity to execute the DPOA or if the SDM's authority is effective. Alternatively, the capacity testing module may determine a set of questions for an legal professional or witness to ask the Grantor whereby the legal professional or witness is provided guidance to make a determination with respect to the Grantor's capacity, or if the legal professional or witness is competent to make a determination of capacity (including, but not limited to, if there is any presence of undue influence at the time instructions are received or the DPOA is executed). In one embodiment, if the legal professional or witness is unable to confirm if the Grantor has capacity or does not feel competent to continue with the capacity assessment, then the legal professional or witness may connect with a capacity assessor to conduct, or schedule, a virtual capacity assessment or an in-person capacity assessment by a qualified capacity assessor through the Connect to Professional Module 218. In another embodiment, the capacity testing module 206 may receive capacity assessments (such as whether or not the Grantor has been deemed to have capacity) and stores this assessment in the database 212. The results of the capacity assessment are stored on the system, with such tracking features that may be used as, time, date the questions that were asked and information presented before and during the assessment. The capacity assessment module 204 will provide a series of statements of the legal professional or witness that will confirm their satisfaction of capacity to proceed or not.

The Undue Influence module 207, operates to assist in making the decision if there is any perceived undue influence over the Grantor. This module may use the responses from the fields of questions/information provided in other modules in FIG. 2 to determine the questions that require further information for the assessor to explore. In one embodiment the module will provide a data bank of questions for the assessor to ask the client/Grantor. In another embodiment the assessor will be provided examples of what the courts within the jurisdiction that the legal document is being signed in, have found to be characteristics, signs or indicia of undue influence or incapacity. In one embodiment, the assessor will be provided a scoring system to assess the risk of undue influence.

The correspondence Module 221, operates to allow a legal professional to send the terms of engagement and/or retainer letter to the client. In one embodiment the client may sign this document using a digital signature or may print off the document in hardcopy form and upload the executed document. The Reporting Module 217, utilizes the tracking and logging module 219 along with any information provided by the user (being the legal professional, SDM or Grantor) to complete a report (in accordance with requirements of the jurisdictional law society) to summarize the transaction. This would include any information provided in the intake module 203, the correspondence module 221, the medical information module 220, the cognitive screening module 213, the capacity assessment module 206, the undue influence module 207, the POA generation module 205. The reporting module 217 may use any of the pre-flagged information that was entered by the user in any of the modules in FIG. 2. For example, it would confirm if the legal professional or witness accepted or refused the engagement or if it was satisfied. The reporting letter will also provide the Grantor or SDM receiving party with the educational piece of information about these documents and some of the uses and what rights they have to revoke the documents. This reporting module may also consider any reports provided through the connection to professional module 218, including without limitations to the capacity assessment report and the link to access the users profile in the system.

The POA, or document, verification module 211 operates to audit the compliance with the jurisdictional formalities of the legal document. In one module, this is auditing process is completed only for DPOAs. In one embodiment the jurisdiction that the document was executed in is selected along with the jurisdiction that the document is attempting to be used in, along with the date of execution and the name of the Grantor. In this embodiment, the module automatically modifies that required fields of information that are required to be input. Based on the information that is input into the system, this module will provide a series of statements required by the person using the document. These statement may be signed virtually by digital signature or a prepopulated document may be formed to print and sign and upload. In one embodiment of this module, the user may use the OCR functionality to scan documents that are uploaded to retrieve text strings or text for populating fields in other databases or other legal documents and/or related health documents. This may reduce the amount of data entry because similar fields may be pre-populated based on the data retrieved by the OCR module 209. After the OCR is completed scanning the document, the user may confirm if the fields are filled in accurately or modify them accordingly. The verification module 211 will provide the user, the Grantor and/or the SDM with an automatically created acknowledgement or sworn document to confirm the statements that the grantor must confirm. For example, in Ontario, subject to all of the required information being input (because otherwise the module would flag the missing information to confirm if it is truly missing or if the user did not enter it) the module would automatically create a document for the relevant party to sign (such as an SDM or grantor).

The Verification Module 211, will also provide the user with guidance to understand how to treat the document in the event that there is missing information. For example, in the event that there are two SDMs listed as the primary SDM arrangement and the DPOA does not say that if the SDMs are supposed to act jointly, severally, if one has a veto vote etc. and the module will confirm that in Ontario (which will change depending on the jurisdiction that they are in) if the information is not specified for how the SDMs are supposed to act, then they are supposed to act jointly. The verification module can distinguish both documents executed in-person and virtually from any jurisdiction. The verification module 211 assesses such things as (among others) the required number of witnesses, prohibited witnesses, criteria for POAs executed outside of Canada to be accepted in this province/territory, events that automatically revoke/terminate the DPOA. For example, if the SDM's spouse was a witness or in some jurisdictions if there was a divorce from the SDM.

The OCR Module 209 can be used to scan and automatically input information by scanning a certain notarized documents or any other Estate Documents.

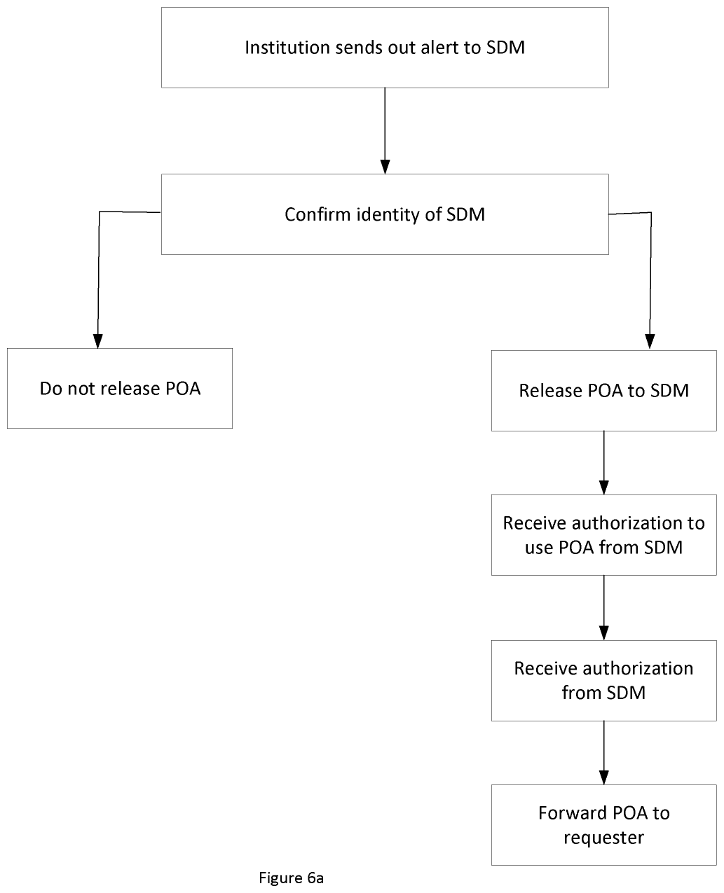

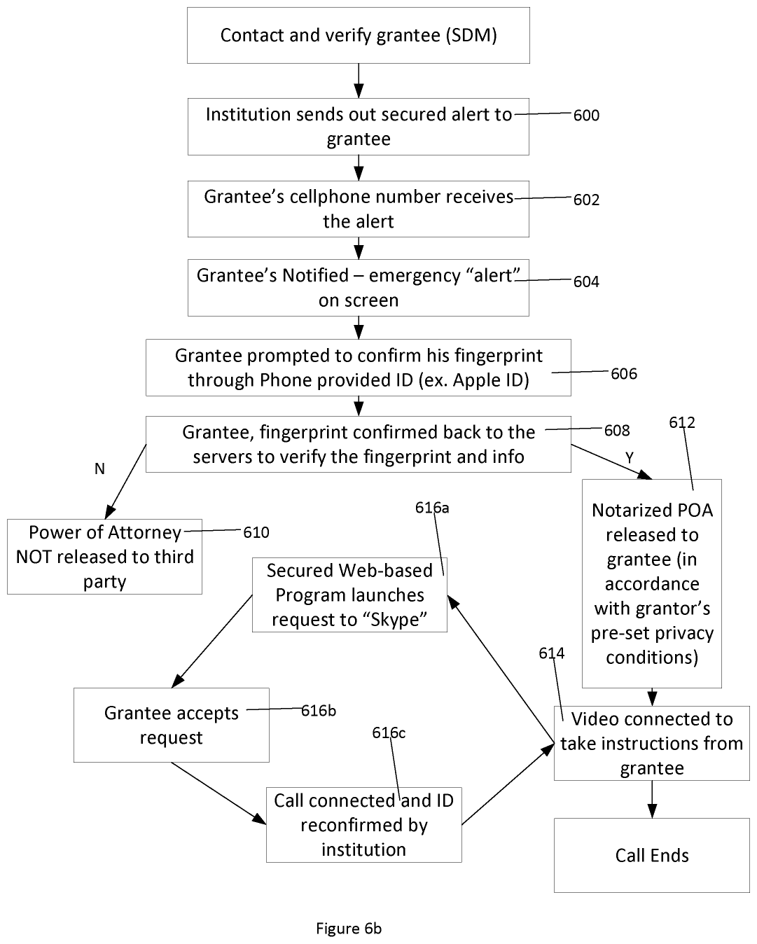

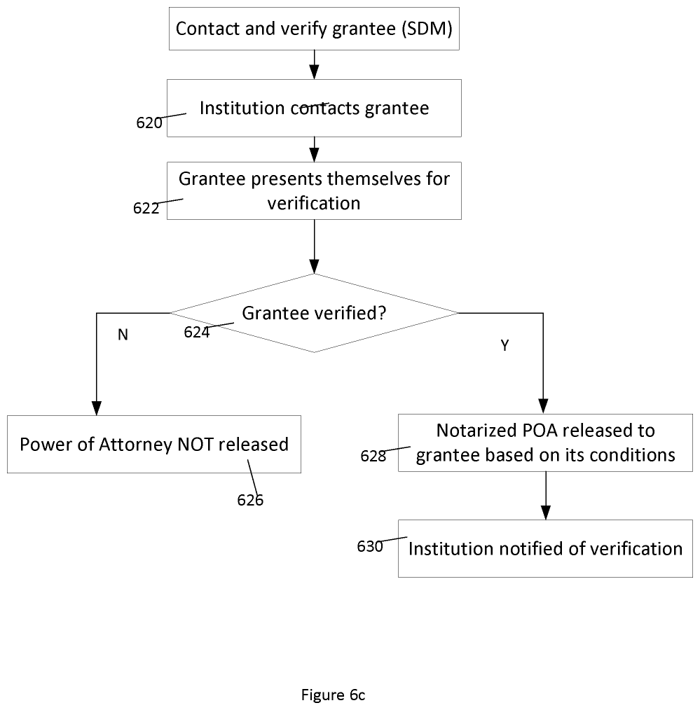

The SDM verification module 210 operates to authenticate or verify an SDM when a decision is required to be made by the SDM. For instance, the SDM verification module 210 may generate or issue at least one test to confirm the SDM's identity. The SDM verification module may also provide the functionality to allow the SDM to digitally provide consent for usage of the DPOA. This may be done via an electronic signature or a video consent. This may be beneficial when the SDM is not in the same jurisdiction or location as the institution requesting the DPOA especially when timing is critical. Examples of authentication are shown with respect to FIGS. 6b and 6c. Another example would be if the SDM upload's a picture of their front and back of their driver's license and then enters the code provided by the module to the SDMs phone or email into the system.

The auditing module 215 assists to generate a log of the actions that have been taken with respect to the POA or legal document and/or related health information/documents. For example, if the POA or legal document and/or a related health document is used for closing a bank account, this action is logged by the auditing module. The tracking function will function with other modules to confirm not only the most recent in time document but also potential patterns. For example, if a Grantor executes three different DPOAs within 3 weeks with different lawyers, then the module will prompt the creating party of this. The logging function will be able to keep track of any decision made by any user. This logging function can be customized to track any of the SDM, the grantor or any third party's use of the DPOA (including the frequency, types of transactions/decision and amounts).

The SDM communication module 218 may assist to connect the system with a SDM, when necessary. The SDM communication module 218 may operate with the communication module 204 to perform this communication. The SDM communication module 218 may also enable a SDM to electronically provide consent to use the DPOA or legal document and/or related health documents. The SDM can send notifications to other related parties.

In operation, the processor, or one of the modules, may also continuously monitor all the changes or updates to a DPOA so that there is log of actions that may be reviewed with respect to each POA within the system. In other embodiments, if there are updates to the POA, any users or individuals associated with the POA may be notified of these updates.

The system 101 may also include a DPOA database 208 for storing any completed DPOAs, templates that are transmitted to users to fill out, completed capacity assessments and/or consents to release the POA Documents and the POA documents. This database may search either or both of the user's private Estate Documents and the greater Estate Documents database.

In one embodiment, the disclosure includes an automated capacity screening, or automated capacity screening functionality, to assist in determining if a Grantor (the individual executing the POA) has complied with the requisite formalities for executing the POA. For example, one determination may be, based on jurisdiction determining if the Grantor had the capacity to execute the DPOA and that there was no undue influence exerted on the Grantor at the time the instructions were taken or the time of execution of the POA.

In another embodiment, the disclosure includes a method of contacting an appointed SDM or an authorized representative that can legally make a decision on the Grantor's behalf, requesting the use of the POA and the authentication of the SDM. In another embodiment of the system, the SDM, capacity assessor or Authorized User may log certain uses/information of the POA or items related to the performance of their duties including, but not limited to, sending consent to accept the appointment, renouncing appointments or declining the appointment.

The file management module 227, will prompt certain users of the system to complete certain tasks or to remind a person of an outstanding task. This may range from providing the legal professional with a reminder to follow up with the client to see how the draft review is progressing or to view which part of the composing process that the client/Grantor is in. In another embodiment the legal professional can track who is assigned the work in the office. In another embodiment the legal professional can toggle reminders to be sent to their clients to update their Wills and POAs, the legal professional can adjust the amount of time that an automated reminder be sent to the Grantor, SDM or the client.

The Notarized document database 201 may be used to upload, store and/or send notarized documents for intended receivers. The processes for sending and retrieval would be the same as in the user document database. The notarized document database may be linked with any of the cognitive impairment screening module 213, capacity assessments 206, and undue influence modules 207 along with the reporting module 217.

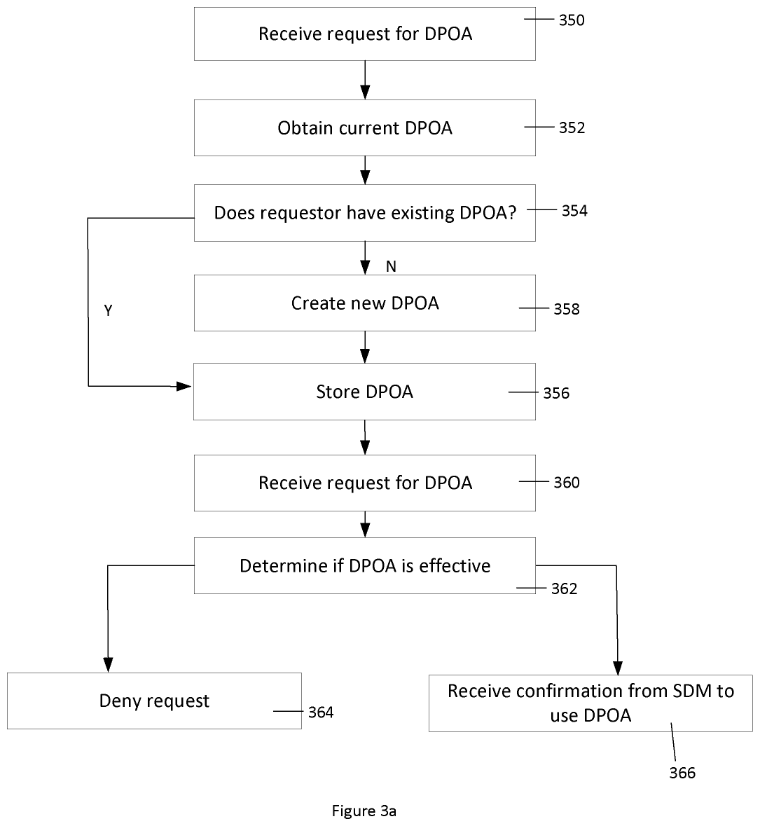

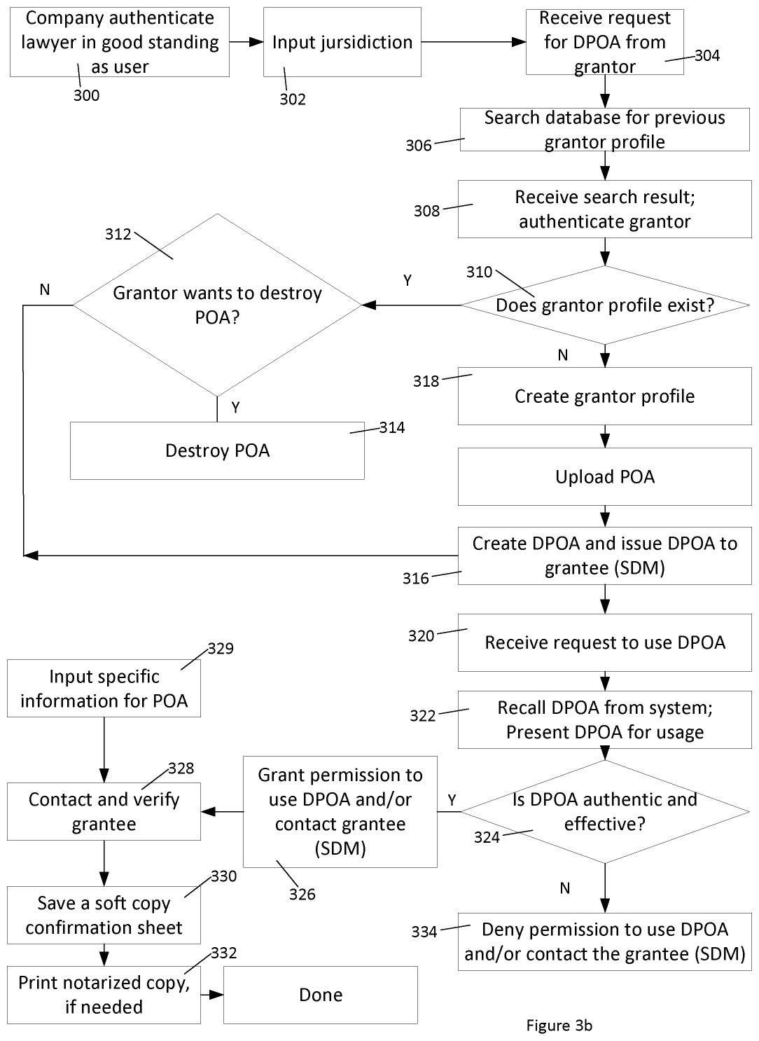

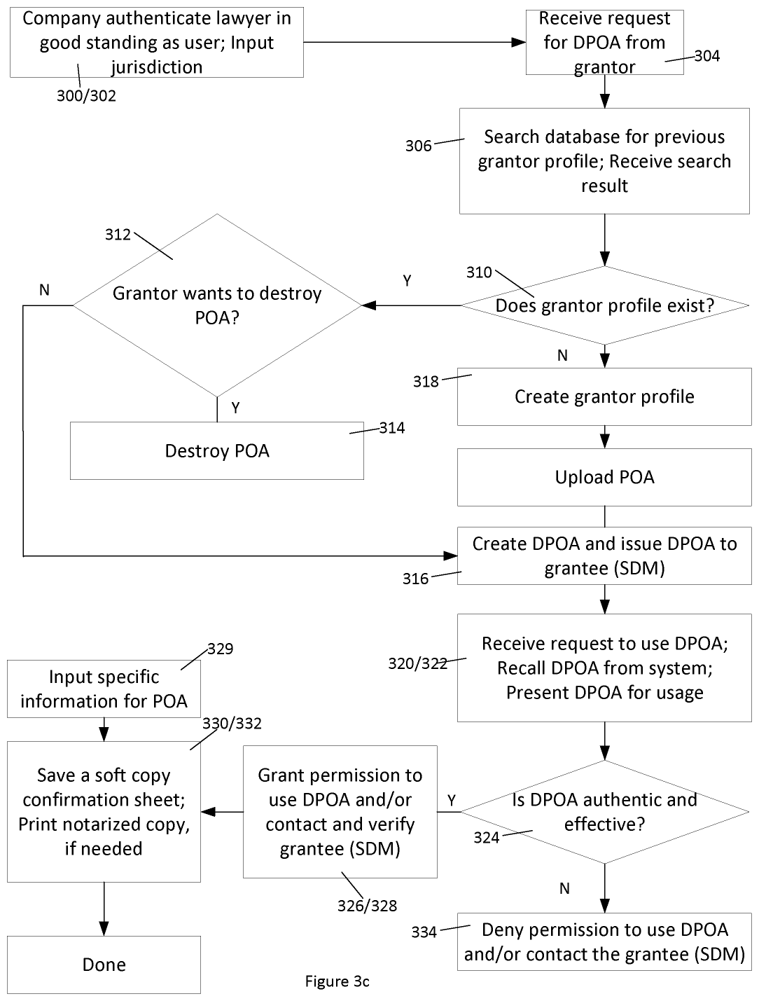

Turning to FIG. 3a, a flowchart outlining one method or auditing and/or issuing a DPOA is shown.

Initially, a request for a DPOA, or current DPOA, for a grantor is received (350) by the system. The system then obtains the current DPOA associated with the grantor (352). In one embodiment, the system searches the POA database to determine if there is an existing DPOA associated with the grantor (354) and, if so, retrieves the existing DPOA as the current DPOA and stores the DPOA (356). If an existing POA is located, the system verifies if the existing POA is effective in the current jurisdiction of the grantor.

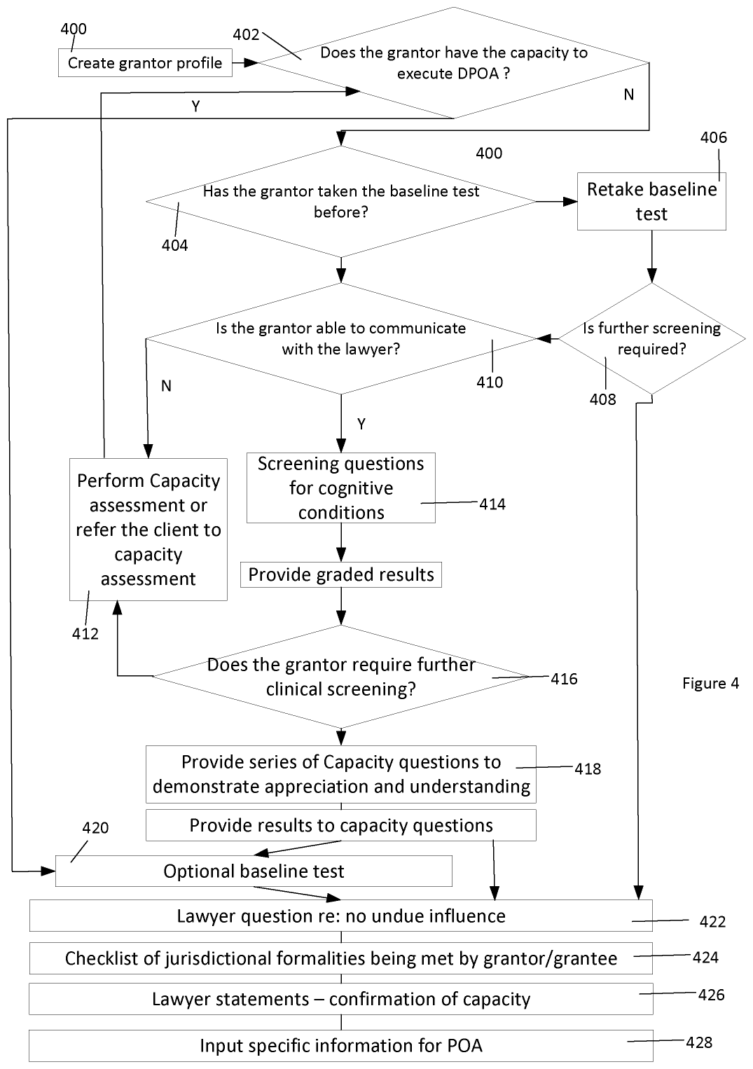

Alternatively, if there is no existing DPOA, the system determines that a new DPOA is to be created (358). One method of creating a new DPOA is shown in FIG. 4. As can be seen in FIG. 4, the creation of the new DPOA may include a capacity assessment for the grantor, if it is determined that a capacity assessment is required. The grantor may also be asked further questions to determine if there may be further investigation required to be performed to determine if further assessment is required. The further investigation may involve conflict of interest matters. Once those assessments are completed, the new DPOA is then stored as the current DPOA (356). After the current DPOA has been stored, it may be retrieved (at a later date) when requested.

When there is a need for the DPOA (such as a request by an institution, or a third party and the like), a request is received by the system for the DPOA (360). A check is then performed to determine if the DPOA is authentic and/or effective (362). If it is not, the request for the DPOA is denied by the system (364). If it is effective, the system awaits confirmation from a SDM to release the DPOA (366). Examples of how this may be performed is shown in FIG. 6a.

Turning to FIG. 3b, a flowchart outlining a more specific method of auditing and/or issuing a DPOA is shown. Initially, the system receives a request from an authorized user (such as a legal professional, or an eligible witness within the relevant jurisdiction or a qualified capacity assessor and the like, hereinafter referred to as “Authorized User”) for the provision of a POA template/information sheet that the Grantor or the Authorized User can fill out for a Grantor to use the system. After receiving the request, the system authenticates the Authorized User that is making the request (300). In one embodiment, this may be done by confirming that an Authorized User is in good standing with the relevant governing college or body overseeing their jurisdictional practice. For example, in the case of the lawyer, the governing Law Society may be contacted to determine this information. This may be performed manually or may be automated by retrieving a list of lawyers in good standing from the Law Society and comparing the lawyer's name with the list. Alternatively, if the user is not a qualified professional the system may ask a series of questions to determine if the witness is qualified to provide the information in the specific jurisdiction. For example, the system may ask if the witness in Ontario is over 18 years old. Alternatively if the user of the software is receiving a DPOA, the system may ask if the receiving person has received the authorization from the organization to bind the company or ask if they completed the corporate policies. If a soft copy is uploaded or a hardcopy is converted into a softcopy then the program may user OCR technology to pull the relevant fields from the document, for example, it would search a power of attorney for the Grantor's name, the substitute decision makers name(s) and alternate substitute decision maker's names and if the document is effective immediately or upon the Grantor's incapacity.

After this has been completed, a request for the jurisdiction the Authorized User is looking at is transmitted and the response received by the system (302). In one embodiment, the Authorized User authentication (300) and the jurisdiction information (302) may be performed once such that the Authorized User is added as an authenticated user by the system and does authentication does not have to be performed each time the method is executed. In some embodiments, the system may then provide an engagement and/or retainer letter if the grantor is a new client.

A request from a Grantor is then received by the system (304). In the current embodiment, it is required that the Grantor be physically located with the requesting Authorized User such that the Authorized User must identify the Grantor using permitted forms of identification. The specified identification details are input into the system. Alternatively, the identification of the Grantor may be automated.

After receiving the confirmed request, the system searches the DPOA database (306) to verify that the Grantor is not already in the database such that the Grantor does not have a previously executed POA (or other Estate Documents) and the search results received or retrieved (308). A determination is then performed to check is the Grantor has an existing profile within the system (310). If it is determined that the Grantor has a previous DPOA/POA or is in the system, the system requests confirmation/verification from the Grantor or the Authorized User that they are the same individual. This may be done via an interactive test or may be performed by the Authorized User by looking the Grantor's identification. If it is confirmed that the Grantor is the same as the Grantor in the system, the Grantor is provided the opportunity to destroy the previous POA (312) or audit the jurisdictional formalities of the existing DPOA. The original POA or DPOA may then be deleted (314) or the original document may be uploaded (316) so that the system can issue the POA to the SDM or may simply link the SDM name to the Grantor profile. Prior to the upload, the system may determine if the existing POA is valid in the grantor's current jurisdiction. For instance, a POA that was originally executed in one jurisdiction may be deemed invalid in another jurisdiction whereby the existing DPOA may no longer be effective. If so, a new DPOA is to be generated, such as discussed below. In one embodiment when the original document is uploaded, it may be checked for compliance with the jurisdictional formalities at the time the document was executed. In the event that insufficient information or non-compliant information is entered, the Authorized User may be provided with a notification outlining the prospective deficiency and/or risk. For example, the system automatically prints off a list of the missing information or the required statements to be made by the presenting party. For instance, in a specific example, if the user did not input two witnesses in Ontario, then it would confirm that unless there are two witnesses, that the power of attorney is invalid.

In one embodiment, if the Grantor's name is not found, a declaration is requested to be signed to confirm the Grantor has no previous POA such that a Grantor profile can be generated (318) or created within the system. Also, if the Grantor decides to delete or destroy their previous POA (314), a new Grantor profile may also be generated (318). If there is not enough information to determine all jurisdictional formalities of an existing POA or DPOA then a declaration is produced automatically to have the relevant party seeking to use the POA or DPOA to declare missing relevant facts.

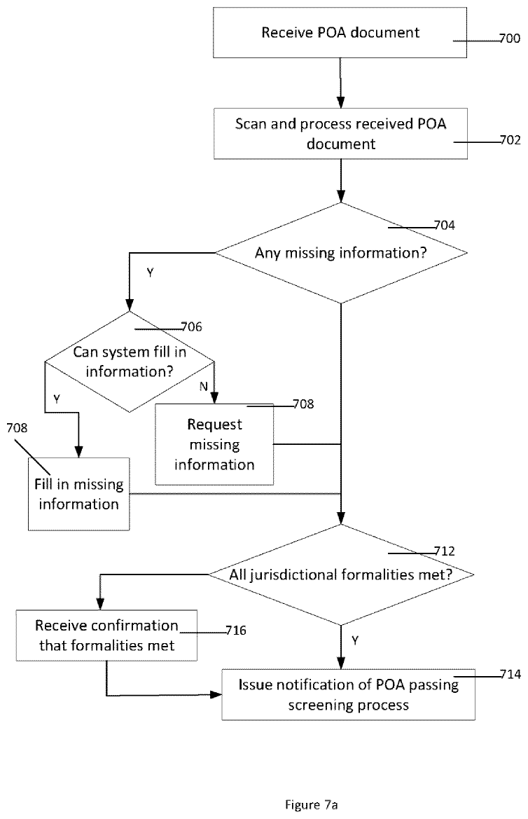

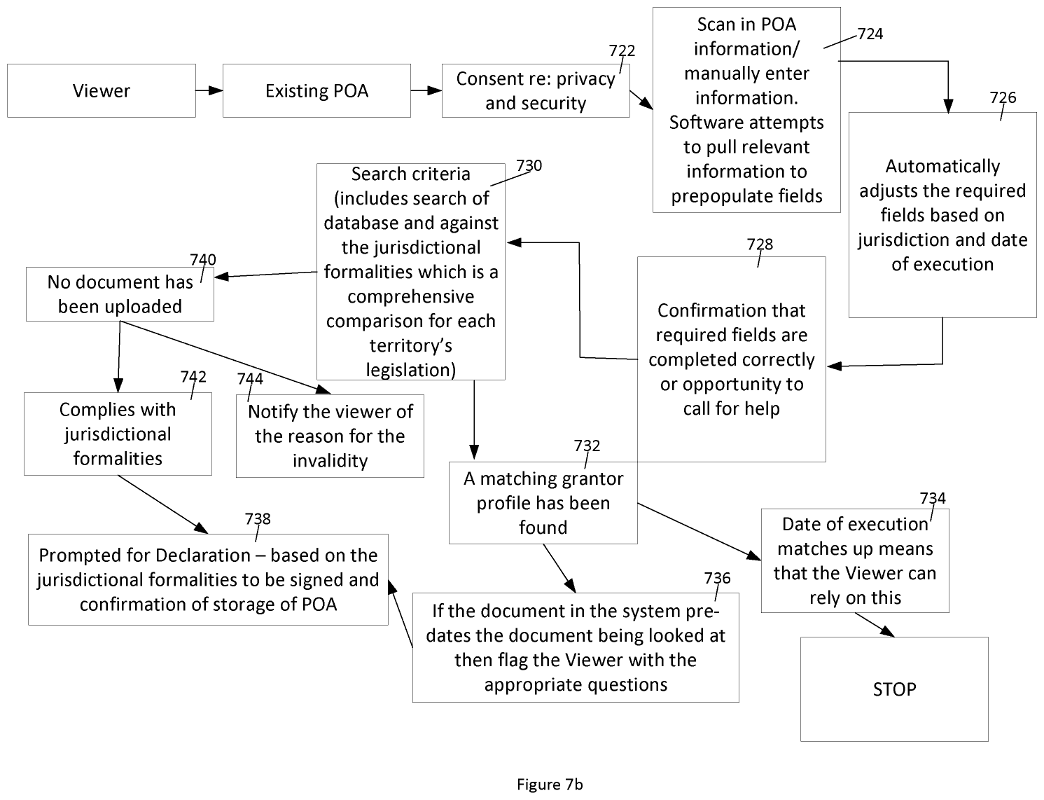

When the new Grantor profile is generated, certain due diligence matters may be addressed in accordance with jurisdictional, such as Law Society, requirements. For instance, confirmation of Grantor name, that no conflicts are present and/or capacity confirmation questions. In another embodiment, the system may perform further due diligence research such as to confirm that there is no undue influence to question responses, the meeting of certain legal requirements and/or information available to SDMs of the POA or DPOA. A method of generating a Grantor profile is described below with respect to FIG. 4. In another method, if a previous POA, DPOA or Estate Document exists, the information may be manually input into the system and/or a copy of the POA or DPOA scanned/transferred into the system for storage and use. FIGS. 7a and 7b show another method of screening a POA that exists and determining if it complies with jurisdictional formalities (explained in more detail below).

Subsequent to the completion of the POA, there may arise a need to retrieve the POA, DPOA or POA Documents. When this occurs, the system receives a request to use, or retrieve, the POA (320) and retrieves the requested POA (320). The request may be received from an institution (such as a hospital, bank, long-term care facility, and the like) that wishes to view the POA, DPOA or POA Documents. In response to request, the system may retrieve the requested POA, DPOA or POA Documents and transmit the SDM's information, contact information provided by the Grantor and any restrictions and limitations of the POA, DPOA or POA Documents (322). In one embodiment, prior to the release of the POA, DPOA and/or POA Documents, the Authorized User may be guided through a series of questions to confirm that the releasor and/or releasee are in compliance with the jurisdictional privacy and security legislation. This embodiment may be accessed through, or separately from, this process, wherein the Authorized User enters the type of document, for example a health record or a POA and then enters other fields describing the intended recipient and recipient's use. For example asking if the disclosure was made because of a concern of health or safety of a person and/or questions about the discloser/recipient to determine which privacy legislation would apply and to suggest best practices in order to increase their compliance with certain privacy legislation. In one example, the system may produce a declaration to create terms for an automatic consent and/or an acknowledgement of risk being assumed. The scoring system behind this automation will be done to reflect the jurisdictional formalities and specific industries such as health care or law.

After the requested POA or DPOA is retrieved, a determination is made to see if the POA or DPOA is authentic and/or effective (324). If it is authentic and effective, the system grants permission for the POA or DPOA to be used, the SDM is contacted (326). If there is a need to use the POA or DPOA, information from the POA may be submitted (329) in order to determine the SDM. If the SDM is contacted (328), a confirmation may be transmitted (330) or a print off notarized copy is issued (332) or both. If the determination is made that the POA is not authentic and/or effective, permission to use the POA is denied by the system and/or the SDM contacted (334). If the POA is not effective because there is no evidence that the Grantor has lost capacity, being the requirement of the POA being effective, then the person (including but not limited to the SDM, Authorized User or the related party) may request a capacity assessment to be scheduled. This capacity assessment may be held virtually or in-person and the results from the capacity assessment uploaded to the system to make the POA or DPOA effective. In an alternative embodiment, if an SDM has not confirmed if they are willing to act as a substitute decision maker then the SDM may provide consent by either producing and uploading his/her own consent document or alternatively a copy may be automatically produced for the SDM to sign. This may be used for the SDM to perform other actions, including, but not limited to, resign, renounce or decline to act as an SDM. In one embodiment, the SDM can track all notifications sent between the SDM and the other parties, but the SDM may also log the various recipients of the POA or DPOA including but not limited to tracking the time, the date, description of transaction, the place of the transaction, and the amount of each transaction. In this embodiment the system may produce these records in a form that is in compliance with the guidelines, rules or legislation of the courts in that particular jurisdiction in accordance with the SDM's duty to account or similar duty thereof.

Turning to FIG. 3c, a flowchart outlining another method of issuing a DPOA or POA is shown. The method of FIG. 3c is similar to that of FIG. 3b with some parts of the method of FIG. 3b combined as a single part or action in FIG. 3c. For example, in FIG. 3c, the authentication that an Authorized User is in good standing (300) and confirmation of the jurisdiction may be performed at the same time. Similarly, when a request is received to retrieve a DPOA, POA and/or POA Documents (320), the retrieval of the DPOA, POA and/or POA Documents (322) and the presentation of the DPOA, POA and/or POA Documents may be performed at the same time. Also, the saving (330) and/or printing (332) of a notarized copy of the DPOA, POA or POA Documents may also be performed at the same time.

It will be understood that other combinations of the method components may also be combined as required or as necessary or where possible. Furthermore, the method of FIGS. 3b and 3c may be seen as a combination of different methods. For instance, the methods of FIGS. 3b and 3c may be seen as including 1) the creation and issue of a DPOA or POA; 2) a request to use the DPOA or POA and; 3) data entry for the DPOA or POA. Furthermore, different method components of the flowchart may be interchanged or combined as will be understood by one skilled in the art.

Turning to FIG. 4, a flowchart outlining a method of generating a Grantor profile for use in a POA or DPOA environment is shown. The creation of the Grantor profile includes the inputting of personal information such as, name, sex, age, address, and the like. In order to allow a POA to be executed, the system also requires a determination (either by using the capacity assessment tools included or by confirmation of a statement of an Authorized User) that a Grantor has the capacity to execute the POA. In one embodiment, this information may be sent to the Grantor via a secured link by an Authorized User of the system. In response, the Grantor may fill out the requested information along with providing the requisite consent and submit the information to the system. The system may then connect the information to the Authorized User of the system and automatically customize the document for editing and final completion. In this embodiment, the information collected may be used in the capacity assessment process and/or in notes or a report that may be automatically created for the Authorized User to summarize the interaction.

Initially, once the Grantor profile has been created and personal information inputted to the system (400), a determination is made to see if the Grantor has had a formal capacity assessment completed (402) in order to confirm that the Grantor has the capacity to execute the POA and/or the DPOA. In one embodiment, the capacity test may be from an authorized capacity assessor of a qualified college (or accredited institution) and performed within a predetermined period of time in order to provide more integrity at the time of receiving instructions and/or the POA. This capacity test may be performed in a predetermined time range (such as potentially within the previous 24 hours) as a Grantor's capacity may change over a short period of time. This capacity assessment or results of the capacity assessment may be uploaded, such as by the capacity assessor, to the system.

If a formal capacity assessment has not been completed, a determination if the Grantor has previously taken a baseline capacity test is made (404). If a baseline test has been previous taken, the baseline test may be taken or performed again (406). Based on the result of the second baseline test, a determination is made to see if further screening, assessment or testing is required (408). If further testing is required or if no baseline test has been previously taken, a determination is made to see (410) whether or not the Authorized User can communicate with the

Grantor. For instance, communication may not be possible due to the incapacity of the Grantor to speak or due to language barriers between the Authorized User and the Grantor. In one embodiment, if the Authorized User is not able to communicate with the Grantor \, the Grantor is referred to a capacity assessor (412).

If the Grantor can communicate with the Authorized User, a set of screening questions, such as to determine cognitive conditions, may be issued by the system (414) or the process may be overridden by the Authorized User confirming that there are no capacity concerns for the Grantor. The system may provide the functionality for the Authorized User's to submit notes.

The screening questions may be issued by the Authorized User or may be delivered on-screen to the Grantor in a language that is understood by the Grantor.

Based on the results, a determination is made by the Authorized User to see if there is further screening required (416) whereby the Authorized User may request that a capacity assessment be carried out by a qualified capacity assessor. If there is a need for a capacity assessment, the Grantor is referred to the capacity assessor (412). If the Grantor does not require further screening, the Grantor may be issued a set of further capacity questions to further determine if the Grantor is able to execute or provide instructions for the POA (418).

The further capacity questions may be used to determine if the Grantor has an appreciation or understanding of what they are doing when executing a POA or DPOA. Examples questions may include, but are not limited to: questions relating to a Grantor's financial situation; questions relating to the Grantor's spending patterns; questions relating to the Grantor's property ownership; questions relating to the Grantor's dependents; questions relating to the Grantor's daily tasks; and/or questions relating to the Grantor's health. It will be understood that these are simply some examples of questions that may be asked and that this list is not an exhaustive list. Alternatively, the system may select a predetermined number of questions from a database of questions. The results are then stored in the system for future review or retrieval. As outlined above, further investigation of certain topics may be required based on answers to questions. This further investigation may be related to conflicts of interest.

Based on the results from the further capacity questions, a further baseline test may be performed or further information may be collected (420). This further baseline test may also be performed if it is determined that the Grantor has had a formal capacity assessment as outlined in 402 above.

The system then receives confirmation that there was no undue influence on the Grantor to execute the POA (422). After confirmation, the system receives confirmation that jurisdictional formalities are met (424) and receives an Authorized User's confirmation of capacity (426). The blank POA can then be issued to the Authorized User for manual signatures (428) and/or digitally signed and stored. In the event that the POA is signed with a manual signature, it is then uploaded back into the system for storage. In both the capacity assessment questions and the undue influence questions, the scoring system will determine the category of risk that the person is potentially subject to undue influence or having risks of capacity, the scoring system may be divided into categories noting the high, medium or low risk of likelihood. In one embodiment, the capacity testing module may include a reasoning engine to determine if the grantor has capacity whereby the reasoning engine may use the scoring system and/or an expert's assessment of the capacity of the grantor. In one embodiment, the system may determine that the grantor is in danger of being incapable of decision-making or incapacitated and generates an alert to a legal representative and/or SDM to activate the POA.

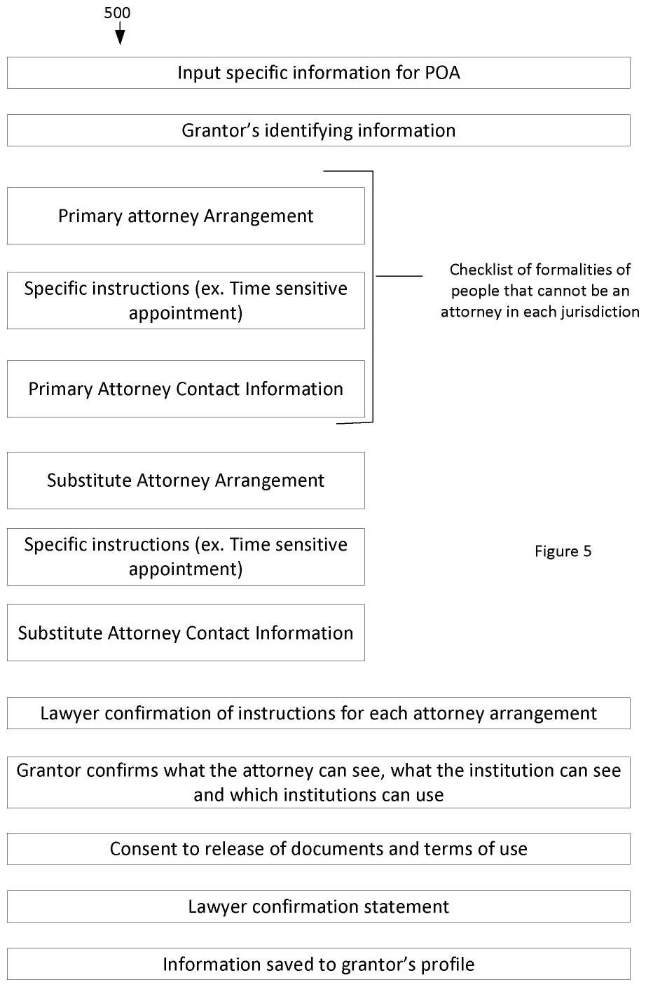

Turning to FIG. 5, a listing of different information that may be used for completing a POA or DPOA is shown. In the current embodiment, the POA or DPOA may require at least one of Grantor's identifying information; primary SDM arrangement; special instructions with respect to the execution of the POA or DPOA; primary SDM contact information; alternative SDM arrangement; alternative SDM contact information; Authorized User confirmation of instructions for each SDM arrangement; Grantor confirmation of entity access to POA or DPOA; consent to release POA or DPOA (when needed); and Authorized User confirmation statement. All of this is preferably stored with the Grantor's profile within the system such that control of what information may be released at specific times is enabled. In the consent to release the POA or DPOA, the Authorized User may be lead through the privacy and/or security screening questions to release or receive the POA, DPOA and/or Documents. In all cases, the Authorized User must provide certain statements about the jurisdictional formalities and/or their due diligence findings.

Turning to FIG. 6c, a method of determining if a POA should be released is shown. In other words, FIG. 6c provides an embodiment of authorizing a SDM.

When there is a need for the POA, an alert or request is transmitted to the SDM (650). Once the SDM has been contacted or response to the alert/request, the identity of the SDM is then confirmed or the SDM is authenticated (652). Examples of how a SDM may be authenticated are shown with respect to FIGS. 6b and 6c. If the SDM is not authenticated, the system not release the POA to the requesting party (654). If the SDM is authenticated, the system then releases the POA to the SDM (656), subject to any supporting documentation being provided, for example, in the event that a POA is required to have a doctor's opinion that the Grantor is no longer capable or managing their affairs or making their own medical decisions, then the SDM or user may access the Activation/Revocation Module 225. In this module, the user is guided through the steps to take in order to activate the authority of the POA. The user will be guided through steps of potentially receiving the doctor's opinion. To this, the user may use the Connect to Professionals Module 218 to connect with a qualified capacity assessor (in this case a doctor) to complete the assessment and then the doctor will be guided to upload the capacity assessment report. If the doctor concludes there is likely to be capacity or incapacity, then the report is uploaded and the status of the DPOA's authority is changed to either active or inactive. In the event that the SDM's authority is active, then the system may automatically send a notification to the primary SDM to consent to act. In the event that there is a finding of incapacity and the SDM has already started to act, then this field will send prompts to the SDM that they cannot renounce or resign (depending on the jurisdictional rule).

In the event that the SDM has the authority to act and the third party requester may then be connected in order for the SDM to provide instructions or authorization to the third party requester. Alternatively, in some embodiments, the SDM may provide authorization for the system to forward the POA to the third party requester (668) which then forwards the POA (670).

Turning to FIG. 6b, a flowchart outlining another method of authenticating a SDM is shown. Once it is determined that there is a need to use the POA, the SDM's information is accessed by an authorized third party (authorized to use the system of the disclosure) who then contacts the SDM using the information provided by the Grantor to the system (600). This is preferably performed in a secure manner such that the status of the Grantor is not made available or public or that is made available only to those that are required to receive an update on the Grantor's status. In one embodiment, this may be enabled by transmitting a message or signal to the cell phone of a SDM (602) potentially as a call or an emergency “alert” (604).

In the current embodiment, the SDM may be asked to provide identification information to the system to confirm the SDM's identity. Examples may include biometric testing, photo identification in an Authorized User's physical location, use of a secret password and the like. In the current embodiment, this may be performed by requesting a fingerprint from the SDM (606). An image of the SDM's fingerprint is then compared with the fingerprint stored on file to confirm the SDM's identity (608). Alternatively, the SDM may be requested to present themselves for identification to an Authorized User (as defined above) or to the third party requesting the instructions of the SDM.

If the SDM's identity is not confirmed (or if the SDM does not consent to act as the SDM after identity is confirmed), the POA is not released (610) and the process is started again for the alternate. If the SDM's identity is confirmed (and the SDM confirms their willingness to act as the substitute decision maker), a notarized DPOA may be released to the SDM in accordance with any special instructions (which must be in compliance with the privacy and security legislation/regulations) in the Grantor profile or alternatively the SDM may attend an Authorized User's location to obtain a notarized copy of the POA (612). The system may then connect the institution or individual requesting the POA, DPOA or Estate Document with the SDM (614) if verbal instructions from the SDM are required. This may be done via a phone call, or a video phone call. In one embodiment, this may be performed using web phone technology (616a-616c).

Turning to FIG. 6c, a flowchart outlining a second method of authenticating a SDM is shown. In order to contact and verify the SDM, the institution contacts the SDM (620). After being contacted, the SDM typically presents themselves for verification by the system (622). In one embodiment, the SDM may travel to the location of the institution making the request. In an alternative embodiment, the SDM may be verified using virtual video technology.

The SDM then needs to be verified by the system (624). Different methods of authentication are contemplated such as outlined above. It will be understood that this is not an exhaustive list of the types of authentication that can be performed to verify the identity of a SDM.

If the SDM is not verified (626), the POA or DPOA is not released. If the SDM is verified, a notarized copy of the POA or DPOA is released to the SDM (628). This release may be subject to conditions previously outlined in the POA or DPOA or via special instructions requested by the Grantor. The requesting institution is then notified by the system that the SDM has been verified (630).

In one embodiment, an improved method of creating, auditing, storing, requesting and/or issuing DPOAs or POAs may include at least one of the following attributes:
creation of POAs in digital format,
searchable digital registry for POAs,
confirmation of the Grantor's capacity by a qualified/regulated person (capacity assessor) to make a POA or DPOA,
confirmation to third parties of validity of POA or DPOA,
confirmation to third parties of identity of SDM seeking to use POA or DPOA,
timely provision to SDMs of a validated copy of the POA or DPOA; and
Support at multiple time points to assessors to improve reliability of capacity assessments.

In another embodiment, the system of the disclosure may include an automated screener or automated screening functionality. One method of automated screening is shown in FIG. 7a. In order to initiate or activate the automated screener, a user of the system must receive the consent from the person who is in possession of the POA or DPOA to upload, use, analyze, store, disclose its information in accordance with the systems terms of use, privacy policy, and/or consent document. In one embodiment, if the consent is received by the user, the user may upload or use a soft copy of an existing POA or DPOA which is then received by the system (700). In one embodiment, the user may drag and drop a copy of the completed POA or DPOA into the designated area of the system (as schematically shown in FIGS. 8a and 8b which is an example of a potential graphical user interface of the system).

The received POA or DPOA document is then scanned, or processed, (702) to determine any information that may be missing from the POA or DPOA (704). Confirmation of the jurisdiction that the POA or DPOA was executed in and the date of its execution is then performed. Based on the date of execution and the jurisdiction that the DPOA or POA was executed in, the required fields will be changed to reflect the jurisdictional formalities that were then in place at that time. The user may then determine if the system is able to fill in the missing information (706). If so, and subject to the confirmation of the user that the information is correct, the system completes the analysis of the POA or DPOA by including the missing information (708). Alternatively, the system may issue a notification to the user identifying the information that is still missing (710) and requesting this missing information be entered. In another embodiment, the system may complete some of the missing information and request the rest from the user. In one embodiment, the missing information that is completed may be based on jurisdictional formalities. In the event that the required information is not entered, then various statements and/or warnings are given about the validity of the POA or DPOA.

After the system determines that the POA or DPOA document has been completed, i.e. all information has been correctly entered, the system processes the completed POA or DPOA to determine if all jurisdictional formalities have been met (712). In one embodiment, this may be performed by comparing the information in the POA or DPOA with a checklist of expected information.

If the completed POA or DPOA meets all the jurisdictional formalities, the system issues a notification that the POA or DPOA has passed the screening process (714). In one embodiment, the POA or DPOA's information may then be stored in the system to prevent or reduce the likelihood that a previous version is used without a warning of its invalidity. If POA or DPOA has not met all of the jurisdictional formalities, the system may generate a document, or statement, for the user to execute declaring he/she has complied with the errors identified by the system. In one example, a user may have to confirm that to the best of their knowledge and belief that this POA or DPOA is the most recent POA or DPOA executed by the Grantor. In another example, in some jurisdictions, the DPOA may be revoked if a couple is divorced, however, since this may not be able to be verified by the system, the system may generate a document for execution confirming the couple is not divorced. The executed document may then be uploaded to the system and the user confirming that this error has been addressed (716). The system may then issue a notification that the POA or DPOA has passed the screening process (714). In one embodiment that system can provide the statements that would be required in verifying that the POA or DPOA is valid. Subject to the requisite consents being obtained, in any case where either a profile is created, a POA or DPOA is uploaded or the jurisdictional formalities are checked, the POA or DPOA information is saved in the repository to be checked against further searches of similar information and flagged in the future when needed.

Turning to FIG. 7b, a method of automatically auditing a POA is shown. It is assumed that the grantor has a copy of a POA but it is unknown whether the POA is the latest version (unconfirmed POA). Consent is initially obtained, such as from the grantor, to create and/or update a POA (722). This consent may relate to privacy or security or both. POA related information, or personal information, can then be inputted, either manually or by the scanning of a document by the OCR module (724) to obtain information to prepopulate any fields for use in the generation or auditing of the POA. In one embodiment, the information may be in the form of an unconfirmed POA. The system then adjusts any required fields based on the date of execution and the jurisdiction (726).

The system then confirms that all required fields have been completed correctly (728) or transmits a message that there are certain fields are empty or not completed correctly. The system may then perform a search (730) of its databases to determine if there is an existing POA for the grantor. If a matching grantor profile (and thereby existing POA) is located (732), the system may compare the date of execution of the unconfirmed POA with the date of execution of the existing POA to determine if the unconfirmed POA is the latest version. If so, it is determined that the existing POA in the system may be used and relied upon (734). If it is determined by the system that the date of execution of the existing POA predates the unconfirmed POA, the system generates a flag (736) to signal the legal professional that there may be an issue with the existing POA. The system may then generate a declaration for execution by the grantor (738) so that the unconfirmed POA can be uploaded to the system to replace the existing POA.

If there is no existing POA found in the search (740), a check is performed on the unconfirmed POA to determine it if complies with jurisdictional formalities (742). If so, the system generates a declaration for execution by the grantor (738) so that the unconfirmed POA can be uploaded to the system to replace the existing POA. If the unconfirmed POA does not comply with jurisdictional formalities, the system generates a message indicating why they unconfirmed POA is invalid (744).

FIGS. 8a to 8c show tables of information that may be obtained by the system for assistance in creating, auditing and management of a legal document and/or related health information/documents. It is understood that these tables are simply examples and that other embodiments may include, less or more or different questions. The system may also allow the user to enter any question or information that they determine may be useful.

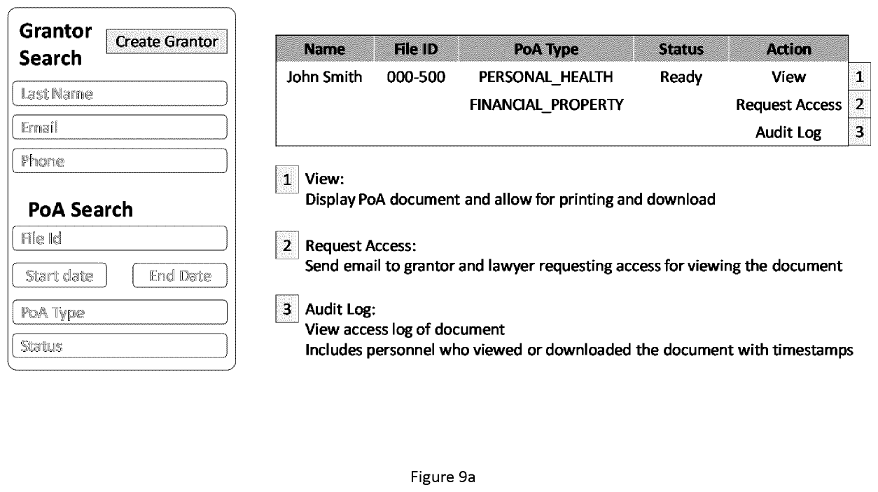

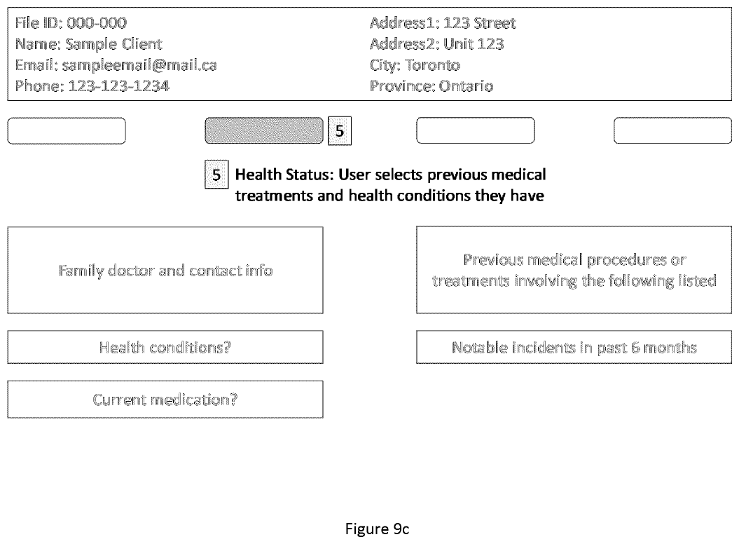

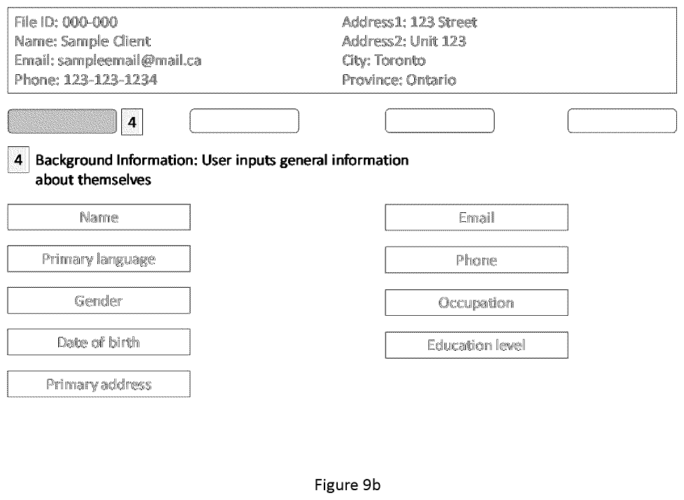

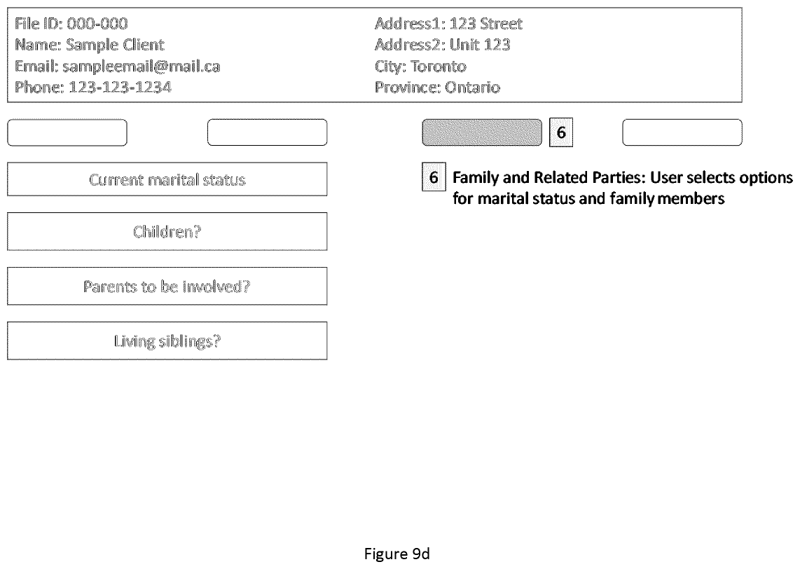

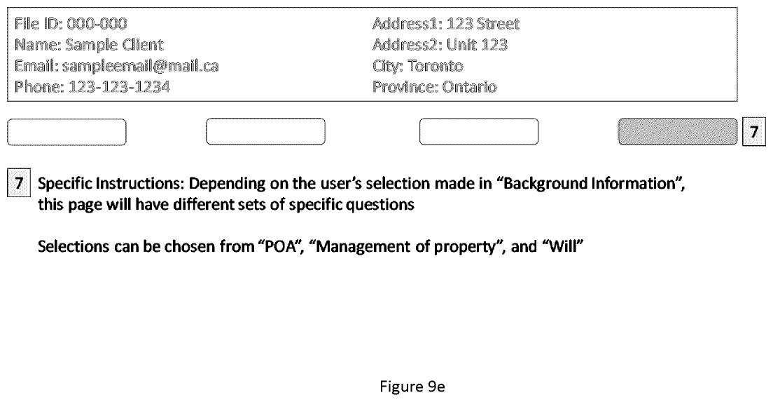

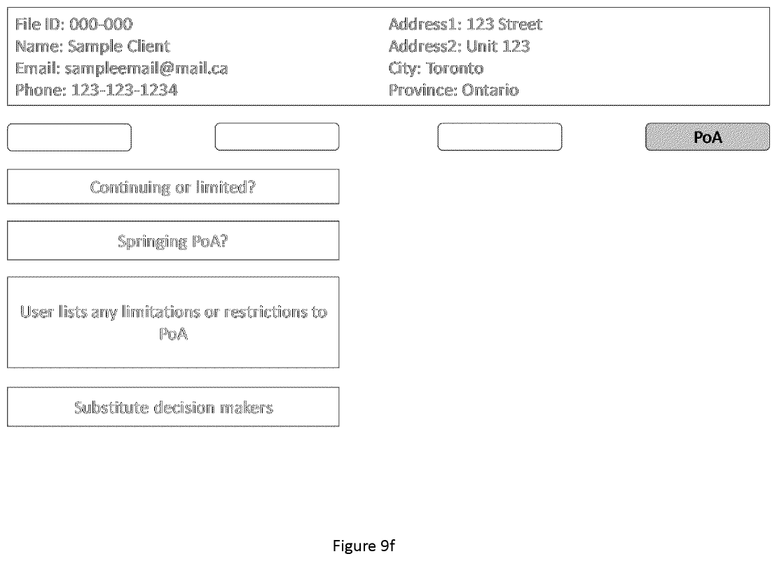

FIGS. 9a to 9f are schematic diagrams of screenshots that a user may see when using the system of the disclosure. As seen in FIG. 9a, the user can view the full audit log of the access of his/her POA document. In this screen, users, such as the grantor or their legal representatives can revoke a POA, which renders the POA inaccessible on the registry, and all parties who accessed, or possessed a paper or digital copy of this POA, will be notified immediately.

In another embodiment, determining if the grantor has capacity and/or undue influence may be based on a scoring system that identifies the clients risks of cognitive vulnerabilities based on information automatically received from the cognitive screening module, the intake module, medical information module; a scoring system that identifies the inconsistent responses with the capacity threshold being measured in the jurisdiction; prompted characteristics or indicia of the court that are either red flags for incapacity or undue influence or the courts have found to be signs of incapacity or undue influence and/or the person administering the capacity assessment or undue influence assessment confirming their decision.

In another embodiment, the system may include functionality to generate or issue a consent to retain/upload document (“consent document”) for a user to execute. The consent document may provide authorization by the user to the system (or owners of the system) to store, search and/or deliver/transmit the POA and relevant information to institutions, when necessary, or to enable other users of the system to search for the POA after it has been stored in the system. In one embodiment, an authorized user may upload a capacity assessment to the system and the system would confirm if that POA or DPOA's authority is effective or not.

In one embodiment, the consent is automatically changed depending on who the recipient is and who the discloser is in order to be in compliance with the privacy and/or security requirements in that jurisdiction. This is facilitated through a series of questions to be answered by the discloser and the recipient. The score or consent will be determined based on the responses provided.

The present disclosure illustrates certain functions which may operate to provide and support the use of DPOAs within a given jurisdiction using both digital and traditional POAs but which is also capable of serving as the jurisdiction wide registry and support infrastructure for a complete system of digital POAs should this be required by the jurisdiction.

In one embodiment, the system and method of the disclosure may be implemented within a blockchain architecture.

In another embodiment, the system may provide other questions to the grantor such as, but not limited to, granting access to the grantor's medical records.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding. For example, specific details are not provided as to whether elements of the embodiments described herein are implemented as a software routine, hardware circuit, firmware, or a combination thereof.

Embodiments of the disclosure or components thereof can be provided as or represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor or controller to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor, controller or other suitable processing device, and can interface with circuitry to perform the described tasks.

1-56. (canceled)

57. A method of managing substitution decision documentation for a power of attorney for a grantor comprising:
obtaining a current power of attorney for the grantor;
determining if the grantor requires a capacity assessment;
administering the capacity assessment;
administering an undue influence assessment;
based on results of the capacity assessment, storing the current power of attorney; and
releasing the power of attorney.

58. The method of claim 57 wherein obtaining the current power of attorney comprises:
determining if the grantor has an existing power of attorney; and
obtaining the existing power of attorney as the current power of attorney if one is found or generating a new power of attorney as the current power of attorney.

59. The method of claim 57 wherein determining if the grantor requires a capacity assessment comprises:
generating a set of questions for the grantor to answer;
processing responses to the set of questions; and
determining if grantor has capacity based on responses to the set of questions.

60. The method of claim 59 wherein determining if grantor has capacity or is vulnerable to undue influence is based on a first scoring system that identifies the clients risks of cognitive vulnerabilities based on information automatically received from the cognitive screening module, the intake module, medical information module; a second scoring system that identifies the inconsistent responses with a legal threshold being measured in the jurisdiction; prompted characteristics or indicia that are signs of incapacity or undue influence or the courts have found to be signs of incapacity or undue influence or a person administering the capacity assessment or undue influence assessment.

61. The method of claim 60 wherein the set of questions comprise questions relating to a financial situation of the grantor, questions relating to spending patterns of the grantor, questions relating to property ownership of the grantor, questions relating to dependents of the grantor, questions relating to daily tasks of the grantor, or questions relating to health of the grantor.

62. The method of claim 58 wherein obtaining the existing power of attorney comprises:
searching a database for the existing power of attorney;
confirming that the grantor is same as individual associated with the existing power of attorney;
determining if the existing power of attorney meets all jurisdictional formalities; and
storing the existing power of attorney as the current power of attorney and revoking authority of conflicting powers of attorney.

63. The method of claim 57 further comprising:
receiving a request from a requestor for the current power of attorney; and
obtaining consent from the grantor or all substitute decision makers (SDMs) to provide the current power of attorney to the requestor.

64. The method of claim 63 wherein obtaining consent from the SDM comprises:
determining if all the SDMs have been authorized by the grantor to make a decision on behalf of the grantor;
confirming identification of all the SDMs; and
obtaining consent from all the SDMs to provide the current power of attorney.

65. The method of claim 64 further comprising, determining if all the SDMs have been authorized comprises:
alerting all the SDMs that the request for the current power of attorney has been received.

66. A system for managing a power of attorney (POA) for a grantor comprising:
a processor including a set of modules for managing a POA, the set of modules including:
an intake module;
a cognitive screening module;
a medical information module;
a capacity assessment module;
a POA generation module for generating the POA; and
a POA database for storing the POA.

67. The system of claim 66 further comprising:
a substitute decision maker (SDM) verification module for determining if an individual is able to act for the grantor.

68. The system of claim 66 wherein the capacity testing module generates questions for performing a capacity assessment and processes responses to the questions to determine if the grantor has capacity.

69. The system of claim 66 further comprising a cognitive screen module, capacity assessment module and medical information module to determine if the grantor's capacity is at high risk.

70. The system of claim 66 further comprising:
a communication module for enabling communication between the system and user devices.

71. A computer-implemented method for managing substitute decision documentation for a power of attorney (POA) for a grantor, comprising:
under the control of one or more computer systems configured with executable instructions, obtaining a current power of attorney for the grantor;
determining if the grantor requires a capacity assessment;
administering the capacity assessment;
administering an undue influence assessment;
based on results of the capacity assessment, storing the current power of attorney; and
releasing the power of attorney.

72. The method of claim 58 further comprising:
generating the new power of attorney via a virtual or electronic methodology or via hardcopy printout and signature.

73. The method of claim 58 further comprising:
automatically completing an affidavit for witnesses.

74. The method of claim 58 further comprising storing a video file associated with the new power of attorney.

75. The method of claim 57 further comprising:
notifying individuals associated with the current power of attorney when it is revoked.

76. The method of claim 58 wherein generating the new power of attorney further comprises:
receiving a digitally signed copy of the new power of attorney or receiving a digital copy of an uploaded hardcopy of the new power of attorney.
